(19) United States
(12) Patent Application Publication
(10) Pub. No.: US 2023/0151128 A1
(43) Pub. Date: May 18, 2023

(54) NEAR INFRARED (NIR) LIGHT CONTROLLED RUTHENIUM CATALYZED OLEFIN METATHESIS

(71) Applicant: The Trustees of Columbia University in the City of New York, New York, NY (US)

(72) Inventors: DAVID C. CABANERO, New York, NY (US); TOMISLAV ROVIS, New York, NY (US)

(21) Appl. No.: 17/977,146

(22) Filed: Oct. 31, 2022

Related U.S. Application Data
(60) Provisional application No. 63/273,503, filed on Oct. 29, 2021.

(51) Int. Cl. C08F 4/80; C08F 2/46

(52) U.S. Cl. CPC C08F 4/80; C08F 2/46

(57) ABSTRACT

Exemplary methods, catalysts, catalyst compositions and systems are provided to activate a latent ruthenium olefin metathesis catalyst using a deep red to near infrared light (e.g., 600-800 nm) in conjunction with an osmium (II) photocatalyst that is directly excited to its triplet state via spin-forbidden excitation. An excited state single electron reduction of a latent solvent coordinated, cationic pre-catalyst is proposed as the operating mechanism for activation and photocontrol, as probed via in situ LED NMR kinetic studies and cyclic voltammetry. Excellent levels of spatiotemporal control can be found under light irradiation. NIR olefin metathesis exhibits improved light penetration through barriers over lower wavelengths of light, a control element that was deployed to mold dicyclopentadiene via Ring Opening Metathesis Polymerization (ROMP).

### CROSS REFERENCE TO RELATED APPLICATIONS

This application relates to and claims the benefit of priority from U.S. Provisional Patent Application No. 63/273,503, filed Oct. 29, 2021, entitled “Near Infrared (NIR) Light Controlled Ruthenium Catalyzed Olefin Metathesis,” the disclosure of which is incorporated herein by reference in its entirety.

### STATEMENT REGARDING FEDERALLYN FUNDED RESEARCH

This invention was made with government support under grant no. 2102672 awarded by the National Science Foundation. The government has certain rights in the invention.

### FIELD OF THE DISCLOSURE

The present disclosure is directed to methods for forming carbon-carbon double bonds, for example, a near-infrared (NIR) photo-controlled method for olefin metathesis, and catalysts and system for performing the methods.

### BACKGROUND INFORMATION

Olefin metathesis is one of the most attractive transformations in the synthetic chemist's arsenal, forming a carbon-carbon double bond with high efficiency under exceedingly mild, functional group tolerant conditions. Indeed, this reaction has deeply impacted synthetic organic chemistry¹⁻⁴, materials and polymer science.^{5,6} With the prospect of controlling metathesis and its mechanistic congeners with high levels of spatial and temporal control, interest in activating latent metathesis catalysts is steadily growing. For instance, Ring Opening Metathesis Polymerization (ROMP) is highly robust and creates mechanically strong polymers; however, its temporal control is still an ongoing challenge. Examples of controlling ROMP through different stimuli have emerged, including electro-^{10,12}, mechano-¹³, and photochemistry.¹⁴⁻¹⁹ Of these, the use of light is highly attractive as it is a mild mode of activation while enabling precise spatial control with high resolution through lasers, and excellent temporal control with the simple flip of the switch.

Several methods have been used to photoactivate latent Ru complexes, such as by activating various benzylidene complexes via UV to visible light or generation of photoacids.¹⁵⁻¹⁷ Metal-free ROMP has been developed using a photocatalyst to oxidize enol ethers.¹⁸ Previously described was a bis-N-heterocyclic carbene (NHC) coordinated Ru complex which when treated with blue light in the presence of an oxidizing photocatalyst leads to light-controlled olefin metathesis.¹⁹

Accordingly, there may be a need to address and/or at least partially overcome at least some of the prior deficiencies described herein.

### SUMMARY OF EXEMPLARY EMBODIMENTS

Such issues and/or deficiencies can at least be partially addressed and/or overcome with the exemplary embodiments of the present disclosure.

To that end, a method for forming a carbon-carbon double bond via Near-Infrared (NIR) photoredox catalysis, as well as a photocatalyst, and a composition comprising catalysts, can be provided according to certain exemplary embodiments of the present disclosure.

According to certain exemplary embodiments of the present disclosure, a composition can be provided for catalyzing formation of a carbon-carbon double bond, the composition comprising: a ruthenium catalyst and a photocatalyst that is activated by a deep red to near infrared light. The deep red to near infrared light may have a wavelength of about 600 nm to about 800 nm.

According to certain exemplary embodiments of the present disclosure, the ruthenium catalyst can comprise, e.g., at least one compound represented by the following Formula (I):

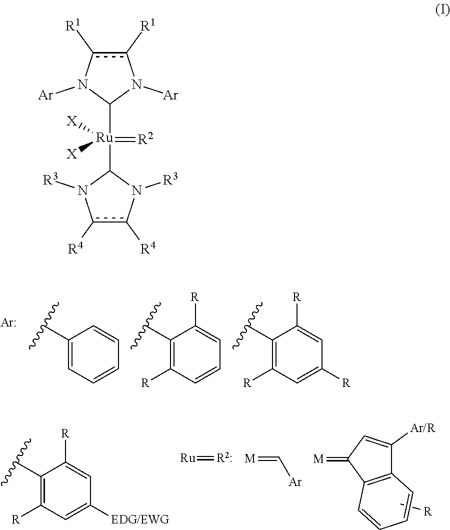

where R can be any aliphatic group

R¹═H or any aliphatic or aromatic group

R³=Any aliphatic or aromatic group

R⁴═H or any aliphatic or aromatic group

NHC ligand may be saturated or unsaturated

X=Halogen or any X-type ligands

In the above Formula (I):
[symbol] indicates a single bond or a double bond.
R¹, R⁴ can, independently, be hydrogen, or any optionally substituted aliphatic group or any optionally substituted aromatic group. For example, R¹, R⁴ can, independently, be an optionally substituted aliphatic group that contains optionally substituted aliphatic group that contains 1-12 aliphatic carbon atoms, or 1-6 aliphatic carbon atoms, or 1-5 aliphatic carbon atoms, or 1-4 aliphatic carbon atoms, or 1-3 aliphatic carbon atoms, or 1-2 aliphatic carbon atoms. This includes, but is not limited to, linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc. In certain embodiments, R¹, R⁴ can, independently, be an optionally substituted aromatic group, such as a phenyl, 2,6-diisopropylphenyl, or mesityl group.
Ru═R² can be

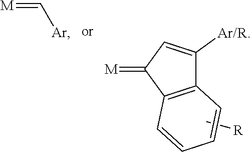

R² can be, for example, a benzylidene group that contain aromatic groups that can independently be substituted with hydrogen or may be substituted with 1-5 substituents, constituting of aliphatic, aromatic, or heteroatom (O, N, S, F, Cl, Br, I, etc.) at any position, or the combination thereof. A substituted indenylidene group of 1-6 substituents, constituting of hydrogen, aliphatic, aromatic, or heteroatom (O, N, S, F, Cl, Br, I, etc.) at any position of the ring, or the combination thereof may also be used.
Each occurrence of Ar can, independently, be

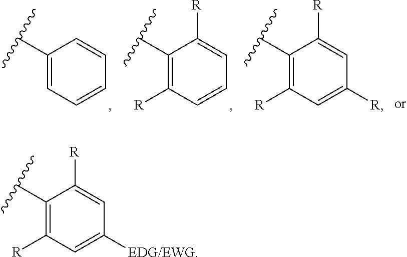

EWG can be ester, cyano, nitro, trifluoromethyl, ketone, halogen, and EDG can be ether, amines, alcohols, and aliphatic groups.
Each occurrence of R can, independently, be any optionally substituted aliphatic group, For example, R may be an optionally substituted aliphatic group that contains optionally substituted aliphatic group that contains 1-12 aliphatic carbon atoms, or 1-6 aliphatic carbon atoms, or 1-5 aliphatic carbon atoms, or 1-4 aliphatic carbon atoms, or 1-3 aliphatic carbon atoms, or 1-2 aliphatic carbon atoms. This includes, but is not limited to, linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc.
R³ can be any optionally substituted aliphatic group or any optionally substituted aromatic group. For example, R³ may be an optionally substituted aliphatic group that contains any number of aliphatic carbons, including linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc. In certain embodiments, R³ may be an optionally substituted aromatic group, such as a phenyl group, 2,6-diisopropylphenyl, or mesityl group.
The bis-N-heterocyclic carbene (NHC) ligand may be saturated or unsaturated.
X can be a halogen, or a X-type ligand. Non-limiting examples of the halogen include F, Cl, Br, I, and combinations thereof. Non-limiting examples of the X-type ligand include CO₃²⁻, O, S, N, and combinations thereof.

For example, the ruthenium catalyst can comprise:

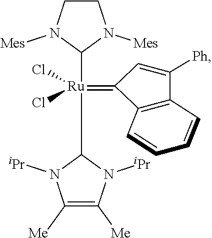

wherein Mes is a mesityl group (C₆H₂(CH₃)₃), ⁱPr is isopropyl, and Ph is phenyl.

According to certain exemplary embodiments of the present disclosure, the photocatalyst may be an osmium photocatalyst. The osmium photocatalyst can comprise:

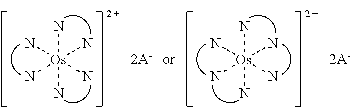

or
a combination thereof, wherein:

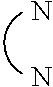

can be

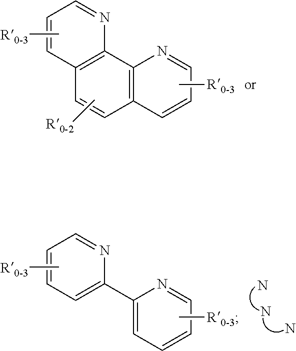

can be

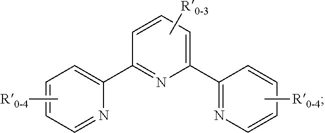

A⁻ can be any suitable anion. Non-limiting examples of A⁻ include Cl⁻, Br⁻, I⁻, NO₃⁻, PF₆⁻, SbF₆⁻, BArF⁻ and a combination thereof
each occurrence of R′ can, independently, be hydrogen, an optionally substituted aliphatic group, an optionally substituted aromatic group, or an optionally substituted functional group containing at least one heteroatom. Non-limiting examples of R′ include an optionally substituted group selected from C₁₋₆ aliphatic, or C₁₋₆ heteroaliphatic having 1-2 heteroatoms independently selected from the group consisting of nitrogen, oxygen, and sulfur, a 5-7-membered heterocyclic ring having 1-2 heteroatoms independently selected from the group consisting of nitrogen, oxygen, and sulfur, a 5-7-membered aromatic ring. In certain exemplary embodiments, R′ may be hydrogen, p-BrC₆H₄ or phenyl.
R′₀₋₂ indicates that 0 to 2 groups of R′ are substituted in a ring to which it is attached;
R′₀₋₃ indicates that 0 to 3 groups of R′ are substituted in a ring to which it is attached; and
R′₀₋₄ indicates that 0 to 2 groups of R′ are substituted in a ring to which it is attached.

For example, the osmium photocatalyst can comprise at least one selected from the group consisting of:

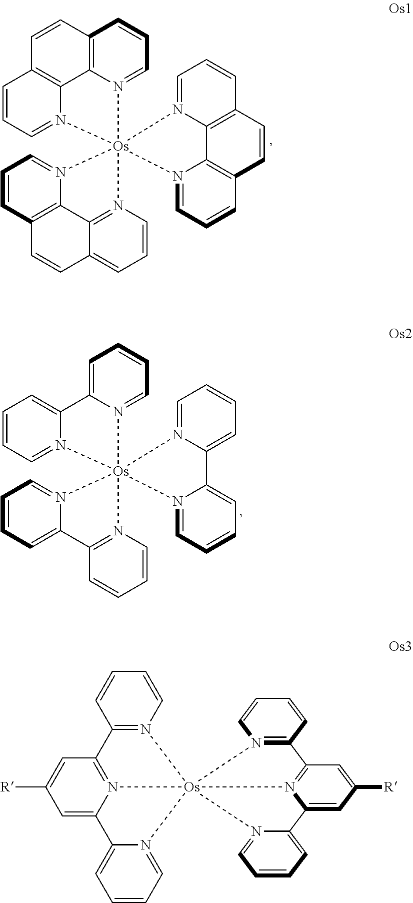

wherein R′ ═H,

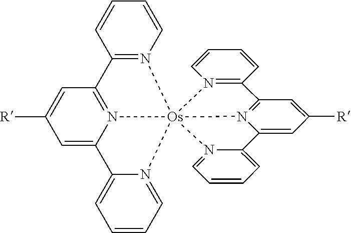

wherein R′=p-BrC₆H₄,

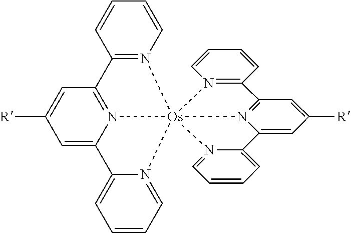

wherein R′ ═Ph, and a combination thereof.

According to certain exemplary embodiments of the present disclosure, a method for catalyzing formation of a carbon-carbon double bond can be provided, the method comprising applying a deep red to near infrared light to a reaction system comprising the catalyst composition according to the present disclosure.

According to certain exemplary embodiments of the present disclosure, a method for chemical metathesis can be provided, which can comprise applying deep red to near infrared light to (i) a compound comprising a first alkenyl group and a second alkenyl group or (ii) a first compound comprising a first alkenyl group and a second compound comprising a second alkenyl group, in the presence of the catalyst composition according to the present disclosure.

According to certain exemplary embodiments of the present disclosure, a method for spatial and/or temporal control of a metathesis can be provided, which can comprise: forming a mixture of a ruthenium catalyst, a photocatalyst, and one or more compounds susceptible to metathesis; and applying a deep red to near infrared light to the mixture at a predetermined time and/or at one or more predetermined regions of the mixture.

According to certain exemplary embodiments of the present disclosure, a photocatalyst comprising the following can be provided:

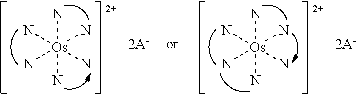

or
a combination thereof, wherein:

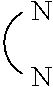

can be or

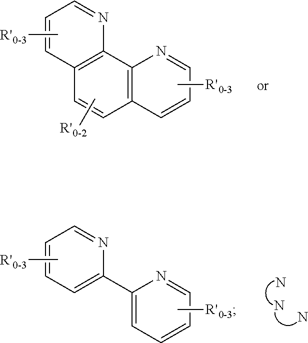

can be

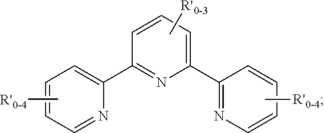

A⁻ can be any suitable anion. Non-limiting examples of A⁻ include Cl⁻, Br⁻, I⁻, NO₃⁻, PF₆⁻, SbF₆⁻, BArF⁻, and a combination thereof.
each occurrence of R′ can, independently, be hydrogen, an optionally substituted aliphatic group, an optionally substituted aromatic group, or an optionally substituted functional group containing at least one heteroatom. Non-limiting examples of R′ include an optionally substituted group selected from C₁₋₆ aliphatic, or C₁₋₆ heteroaliphatic having 1-2 heteroatoms independently selected from the group consisting of nitrogen, oxygen, and sulfur, a 5-7-membered heterocyclic ring having 1-2 heteroatoms independently selected from the group consisting of nitrogen, oxygen, and sulfur, a 5-7-membered aromatic ring. In certain exemplary embodiments, R′ may be hydrogen, p-BrC₆H₄, phenyl, or aromatic heterocyclic rings containing 1-2 nitrogens.
R′₀₋₂ indicates that 0 to 2 groups of R′ are substituted in a ring to which it is attached;
R′₀₋₃ indicates that 0 to 3 groups of R′ are substituted in a ring to which it is attached; and
R′₀₋₄ indicates that 0 to 2 groups of R′ are substituted in a ring to which it is attached.

According to certain exemplary embodiments of the present disclosure, a photocatalyst comprises at least one selected from the group consisting of:

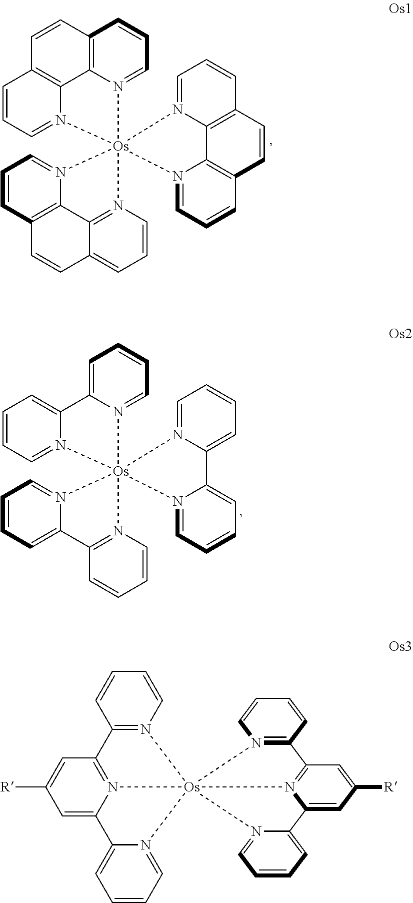

wherein R′═H,

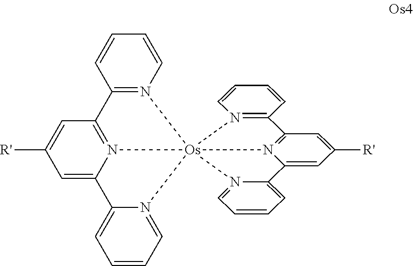

wherein R′=p-BrC₆H₄,

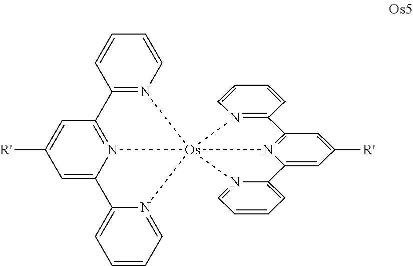

wherein R′═Ph, and
a combination thereof.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF DRAWINGS

Further objects, features and advantages of the present disclosure will become apparent from the following detailed description taken in conjunction with the accompanying Figures showing illustrative embodiments of the present disclosure, in which:

FIG. 1 is an exemplary graph showing exemplary temporal control of NIR Metathesis and applications of NIR ROMP;

FIG. 2 is an illustration of an exemplary flip test for polymerization and crosslinking of dicyclopentadiene through Hemoglobin solution;

FIG. 3 is an illustration of an exemplary procedure using a laser clamped to an orbital shaker to draw polymers using light;

FIG. 4 is an illustration of exemplary electrochemical data of RuCl₂SIMes(IiPrMe)(ind) vs. Ag/AgCl;

FIG. 5 is an illustration of exemplary electrochemical data of RuCl₂SIMes(PCy₃)(benz) Grubbs' II and RuCl₂(SIMes)(PCy₃)(ind);

FIG. 6A is an illustration of exemplary electrochemical data of addition of nBu₄C₁ studies (equiv. relative to [Ru]);

FIG. 6B is an illustration of a graph of exemplary UV-Visible spectroscopy of the Ruthenium precatalyst, the Osmium photocatalyst, its mixture, and the emission of the Osmium photocatalyst;

FIG. 7 is an illustration of an exemplary On/Off study;

FIG. 8 is a graph indicating that an exemplary time study for the consumption of COD suggests slow activation procedure/step;

FIG. 9 is a set of graphs of exemplary raw data plotted with slopes (left), and normalized data (right);

FIG. 10 is an exemplary graph showing that addition of nBu₄PF₆ to Ru complex in acetone leads to NHC dissociation; and

FIG. 11 is a graph and an illustration of an exemplary COSY of Ru and Os1 mixture showing dissociation of IiPrMe via loss of diastereotopic isopropyl protons.

FIG. 12 shows a result of an exemplary polymerization method.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the certain exemplary embodiments illustrated in the figures and the appended claims.

FIG. 13 shows an example of photocatalyst screening and CV study.

FIG. 14A shows initiation kinetics versus [Cl⁻] in a time study for the ring opening of 1,5-cyclooctadiene.

FIG. 14B shows evidence of cationic complex via a cyclic voltammetry study.

### DETAILED DESCRIPTION OF EXEMPLARY EMBODIMENTS

Olefin metathesis is a powerful method of forming carbon-carbon double bonds. Controlling olefin metathesis in response to an external stimulus is desirable for applications in polymer patterning and 3D printing where chemical reactivity needs to be precisely activated/deactivated. Light provides an attractive stimulus since it is minimally invasive and contains high temporal and spatial resolution. Still, existing methods for photocontrolled olefin metathesis rely on high energy wavelengths of light, which suffer from poor barrier penetration depth and commercial applicability.

The following exemplary Scheme 1 shows some recent work on photo-controlled olefin metathesis.

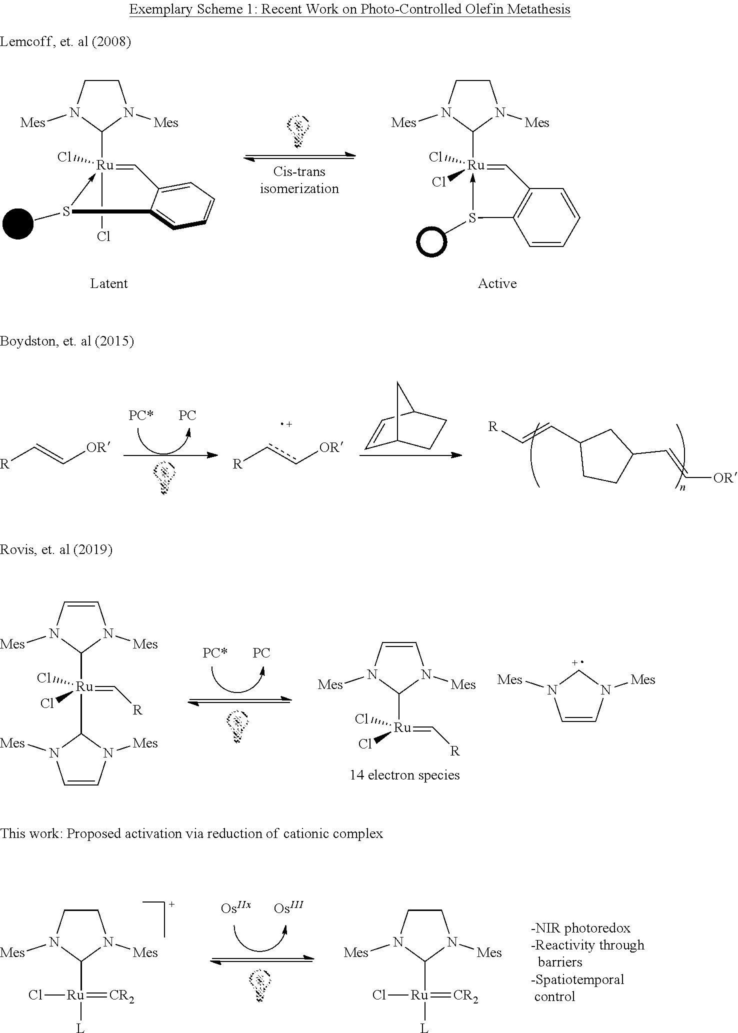

According to certain exemplary embodiment of the present disclosure, exquisite control of formation of a carbon-carbon double bond, such as in olefin metathesis, via Near-Infrared (NIR) photoredox catalysis can be provided. The exemplary systems and methods not only offer full spatiotemporal control for the catalyzed metathesis reaction, but also provide all advantages of NIR light over blue light regarding barrier penetration, allowing new ways to mold polymers.

According to certain exemplary embodiment of the present disclosure, technology relating to a near-infrared (NIR) photocontrolled method for olefin metathesis can be provided. This system may comprise a latent ruthenium olefin metathesis catalyst paired with an osmium photocatalyst, and can catalyze ring-closing metathesis and ring-opening metathesis polymerization transformations. The combination of spatiotemporal control afforded by light-activated catalysis with the higher penetration depth of low energy NIR light activation allows for a robust system capable of polymerizing dicyclopentadiene through a silicone mold. As such, this technology offers innovative ways to pattern polymers with high levels of spatiotemporal control.

According to certain exemplary embodiments of the present disclosure, a catalyst composition can be provided for catalyzing formation of a carbon-carbon double bond. The composition can comprise, e.g.: a ruthenium catalyst and a photocatalyst that is activated by a deep red to near infrared light. In certain exemplary embodiments, the deep red to near infrared light may have a wavelength of about 600 nm to about 800 nm.

According to certain exemplary embodiments of the present disclosure, a method for catalyzing formation of a carbon-carbon double bond can be provided, which can comprise, e.g., applying a deep red to near infrared light to a reaction system comprising the catalyst composition according to the present disclosure. In certain exemplary embodiments, the deep red to near infrared light can have a wavelength of about 600 nm to about 800 nm.

According to certain exemplary embodiments of the present disclosure, a method for chemical metathesis can be provided, which comprises, e.g., applying a deep red to near infrared light to (i) a compound comprising a first alkenyl group and a second alkenyl group or (ii) a first compound comprising a first alkenyl group and a second compound comprising a second alkenyl group, in the presence of the catalyst composition according to the present disclosure. In certain exemplary embodiments, the deep red to near infrared light may have a wavelength of about 600 nm to about 800 nm.

According to certain exemplary embodiments of the present disclosure, a method for spatial and/or temporal control of a metathesis can be provided, which comprises, e.g.: forming a mixture of a ruthenium catalyst, a photocatalyst, and one or more compounds susceptible to metathesis; and applying a deep red to near infrared light to the mixture at a predetermined time and/or at one or more predetermined regions of the mixture. In certain exemplary embodiments, the deep red to near infrared light may have a wavelength of about 600 nm to about 800 nm.

As used herein, the following definitions shall apply unless otherwise indicated.

The term “aliphatic” or “aliphatic group,” as used herein, means a straight-chain (i.e., unbranched) or branched, substituted or unsubstituted hydrocarbon chain that is completely saturated or that contains one or more units of unsaturation, or a monocyclic hydrocarbon or bicyclic hydrocarbon that is completely saturated or that contains one or more units of unsaturation, but which is not aromatic (also referred to herein as “carbocycle,” “cycloaliphatic” or “cycloalkyl”), that has a single point of attachment to the rest of the molecule. Unless otherwise specified, aliphatic groups may contain 1-12 aliphatic carbon atoms. In some embodiments, aliphatic groups contain 1-6 aliphatic carbon atoms. In some embodiments, aliphatic groups contain 1-5 aliphatic carbon atoms. In other embodiments, aliphatic groups contain 1-4 aliphatic carbon atoms. In still other embodiments, aliphatic groups contain 1-3 aliphatic carbon atoms, and in yet other embodiments, aliphatic groups contain 1-2 aliphatic carbon atoms. In some embodiments, “cycloaliphatic” (or “carbocycle” or “cycloalkyl”) refers to a monocyclic C3-C6 hydrocarbon that is completely saturated or that contains one or more units of unsaturation, but which is not aromatic, that has a single point of attachment to the rest of the molecule. Suitable aliphatic groups include, but are not limited to, linear or branched, substituted or unsubstituted alkyl, alkenyl, alkynyl groups and hybrids thereof such as (cycloalkyl)alkyl, (cycloalkenyl)alkyl or (cycloalkyl)alkenyl.

The term “heteroatom” means, for example, one or more of oxygen, sulfur, nitrogen, phosphorus, or silicon (including, any oxidized form of nitrogen, sulfur, phosphorus, or silicon; the quaternized form of any basic nitrogen or; a substitutable nitrogen of a heterocyclic ring).

The term “unsaturated,” as used herein, means that a moiety has one or more units of unsaturation.

The term “aryl” used alone or as part of a larger moiety as in “aralkyl,” “aralkoxy,” or “aryloxyalkyl,” refers to monocyclic or bicyclic ring systems having a total of five to fourteen ring members, wherein at least one ring in the system is aromatic and wherein each ring in the system contains 3 to 7 ring members. The term “aryl” may be used interchangeably with the term “aryl ring.”

In certain embodiments of the present invention, “aryl” refers to an aromatic ring system which includes, but not limited to, phenyl, biphenyl, naphthyl, anthracyl and the like, which may bear one or more substituents. Also included within the scope of the term “aryl,” as it is used herein, is a group in which an aromatic ring is fused to one or more non-aromatic rings, such as indanyl, phthalimidyl, naphthimidyl, phenanthridinyl, or tetrahydronaphthyl, and the like.

According to certain exemplary embodiments of the present disclosure, a photocatalyst comprising at least one compound represented by the following Formula (I) can be provided:

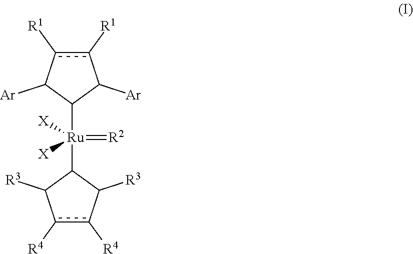

In the above Formula (I):
[symbol] indicates a single bond or a double bond.
R¹, R⁴ can, independently, be hydrogen, or any optionally substituted aliphatic group or any optionally substituted aromatic group. For example, R¹, R⁴ can, independently, be an optionally substituted aliphatic group that contains optionally substituted aliphatic group that contains 1-12 aliphatic carbon atoms, or 1-6 aliphatic carbon atoms, or 1-5 aliphatic carbon atoms, or 1-4 aliphatic carbon atoms, or 1-3 aliphatic carbon atoms, or 1-2 aliphatic carbon atoms. This includes, but is not limited to, linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc.
   In certain embodiments, R¹, R⁴ can, independently, be an optionally substituted aromatic group, such as a phenyl group, 2,6-diisopropylphenyl, or mesityl group, etc.
Ru═R² can be

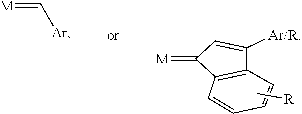

R² can be, for example, phenyl groups that can independently be substituted with hydrogen or may be substituted with 1-5 substituents, constituting of aliphatic, aromatic, or heteroatom (O, N, S, F, Cl, Br, I, etc.) at any position, or the combination thereof. Substituted indenyl groups of 1-6 substituents, constituting of hydrogen, aliphatic, aromatic, or heteroatom (O, N, S, F, Cl, Br, I, etc.) at any position of the ring, or the combination thereof may also be used.
Each occurrence of Ar can, independently, be

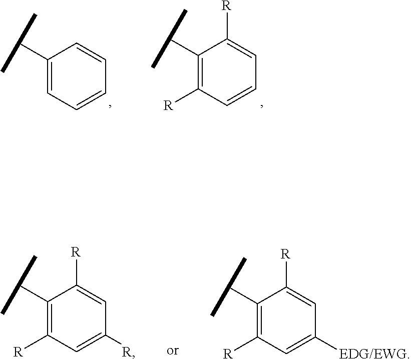

EWG can be ester, cyano, nitro, trifluoromethyl, ketone, halogen, and EDG can be ether, amines, alcohols, and aliphatic groups.
Each occurrence of R can, independently, be any optionally substituted aliphatic group, For example, R may be an optionally substituted aliphatic group that contains optionally substituted aliphatic group that contains 1-12 aliphatic carbon atoms, or 1-6 aliphatic carbon atoms, or 1-5 aliphatic carbon atoms, or 1-4 aliphatic carbon atoms, or 1-3 aliphatic carbon atoms, or 1-2 aliphatic carbon atoms. This includes, but is not limited to, linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc.
R³ can be any optionally substituted aliphatic group or any optionally substituted aromatic group. For example, R³ may be an optionally substituted aliphatic group that contains optionally substituted aliphatic group that contains 1-12 aliphatic carbon atoms, or 1-6 aliphatic carbon atoms, or 1-5 aliphatic carbon atoms, or 1-4 aliphatic carbon atoms, or 1-3 aliphatic carbon atoms, or 1-2 aliphatic carbon atoms. This includes, but is not limited to, linear chains such as methyl, ethyl, propyl, butyl, etc. as well as branched aliphatic groups such as isopropyl, isobutyl, etc. This group can also be saturated rings or unsaturated rings such as cyclopentyl, cyclohexyl, etc.
In certain embodiments, R³ may be an optionally substituted aromatic group, such as a phenyl, 2,6-diisopropylphenyl, or mesityl group.
The bis-N-heterocyclic carbene (NHC) ligand may be saturated or unsaturated.
X can be a halogen, or a X-type ligand. Non-limiting examples of the halogen include F, Cl, Br, I, and combinations thereof. Non-limiting examples of the X-type ligand include CO₃²⁻. O, S, N, and combinations thereof.

For example, the ruthenium catalyst can comprise:

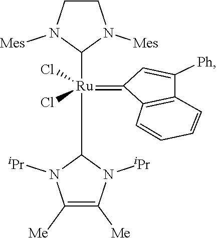

wherein Mes is a mesityl group (C₆H₂(CH₃)₃), ⁱPr is isopropyl, and Ph is phenyl.

According to certain exemplary embodiments of the present disclosure, a photocatalyst comprising the following can be provided:

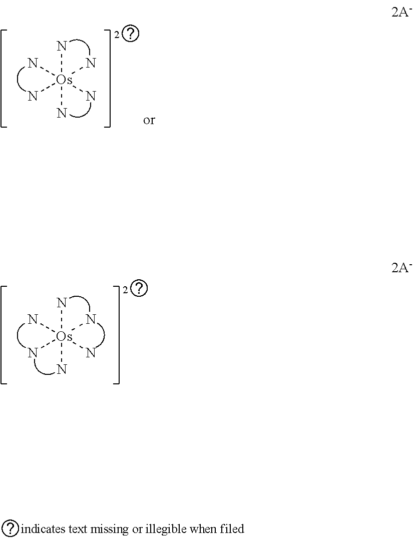

or
a combination thereof, wherein:

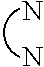

can be or

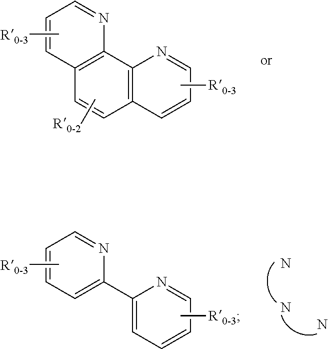

can be

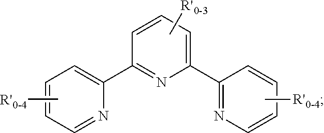

A⁻ can be any suitable anion. Non-limiting examples of A⁻ include Cl⁻, Br⁻, I⁻, NO₃⁻, PF₆⁻, SbF₆⁻, BArF⁻, and a combination thereof.
each occurrence of R′ can, independently, be hydrogen, an optionally substituted aliphatic group, an optionally substituted aromatic group, or an optionally substituted functional group containing at least one heteroatom. Non-limiting examples of R′ include an optionally substituted group selected from C₁₋₆ aliphatic, or C₁₋₆ heteroaliphatic having 1-2 heteroatoms independently selected from the group consisting of nitrogen, oxygen, and sulfur, a 5-7-membered heterocyclic ring having 1-2 heteroatoms independently selected from the group consisting of nitrogen, oxygen, and sulfur, a 5-7-membered aromatic ring. In certain exemplary embodiments, R′ may be hydrogen, p-BrC₆H₄, phenyl, or aromatic heterocyclic rings containing 1-2 nitrogens.
R′₀₋₂ indicates that 0 to 2 groups of R′ are substituted in a ring to which it is attached;
R′₀₋₃ indicates that 0 to 3 groups of R′ are substituted in a ring to which it is attached; and
R′₀₋₄ indicates that 0 to 2 groups of R′ are substituted in a ring to which it is attached.

According to certain exemplary embodiments of the present disclosure, a photocatalyst comprises at least one selected from the group consisting of:

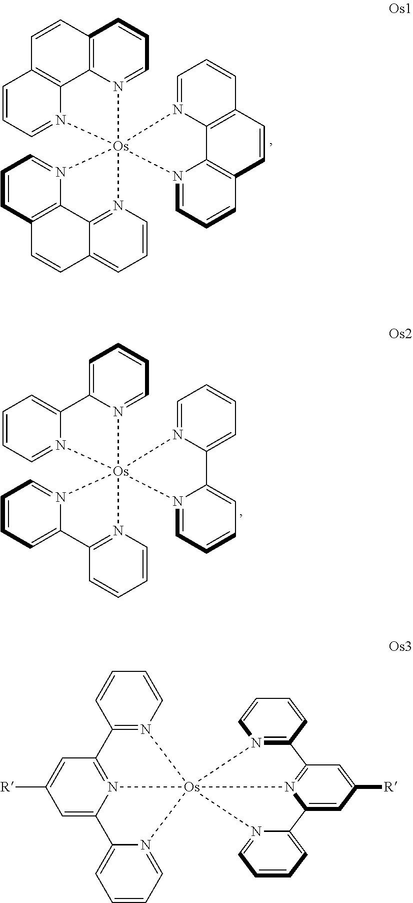

wherein R′═H,

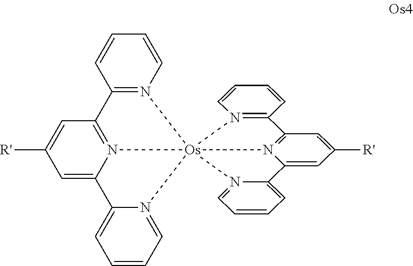

wherein R′=p-BrC₆H₄,

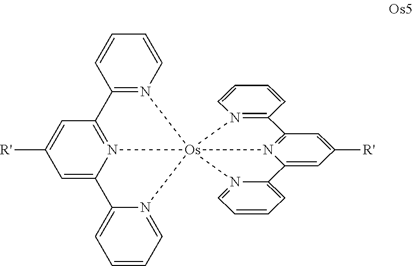

wherein R′=Ph, and
a combination thereof.

The exemplary embodiments of the present disclosure is illustrated herein by the following examples, which should not be construed as in any way limiting. The contents of all references, pending patent applications and published patents, cited throughout this application are hereby expressly incorporated by reference. Those skilled in the art will understand that these exemplary embodiments of the present disclosure may be embodied in many different forms and should not be construed as limited to the embodiments set forth herein. Rather, these exemplary embodiments are provided so that the present disclosure will fully convey the exemplary embodiment of the present disclosure to those skilled in the art. Various exemplary modifications and other exemplary embodiments of the present disclosure will come to mind in one skilled in the art to which this invention pertains having the benefit of the teachings presented in herein. Although specific terms are employed, they are used as in the art unless otherwise indicated.

### EXAMPLES

According to certain exemplary embodiment of the present disclosure, more easily activated complexes that still maintain latency of the ruthenium olefin metathesis catalyst at ambient temperatures can be provided. A set of mixed bis-NHC phenylindenylidene catalysts that contain a SIMes ligand trans to a smaller, more labile NHC ligand has been previously reported by the Nolan group²², where the SIMes-IMe and SIMes-ICy derivatives were successfully used for low catalyst loading metathesis (0.02 mol %); however, it was found that the 1,3-diisopropyl-4,5-dimethylimidazol-2-ylidene (IiPrMe) derivative did not perform well under thermal conditions. The present inventors hypothesized that this inactive, but more labile bis N-heterocyclic carbene (NHC) ruthenium complex may be susceptible to activation using Os photocatalysts.²²By virtue of a direct S₀—Ti excitation itself enabled by spin-orbit coupling, these Os complexes are directly excited to their triplet excited state using NIR light, avoiding energy loss associated with Intersystem Crossing (ISC).

TABLE 1
RCM Optimization and Scope

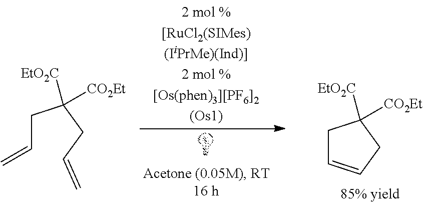 [SMILES: C=CCC(CC=C)(C(=O)OCC)C(=O)OCC ; CCOC(=O)C1(C(=O)OCC)CC=CC1]

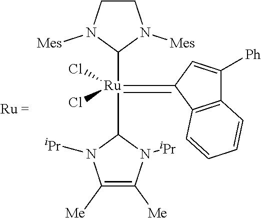

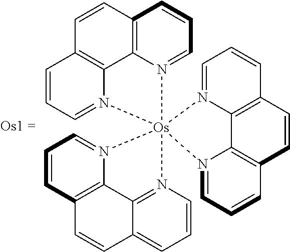

| Entry | Conditions | Yield³ |
|---|---|---|
| 1 | 1 mol % Os1, 0.2 M | 22 |
| 2 | 1 mol % Os1, 0.1 M | 41 |
| 3 | 1 mol % Os1, 0.05 M | 73 |
| 4 | 2 mol % Os1, 0.05 M | 85 |
| 5 | 2 mol % Os1, 0.05 M, no light | trace |
| 6 | Ru only, 0.05M, light | trace |
| 7 | Ru only, 0.05M, no light | trace |

Ring Closing Metathesis 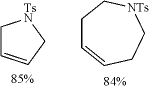 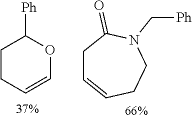
^{a}Yield by ¹H NMR using 1,3,5-trimethoxybenzene as internal standard

The ring closing metathesis (RCM) of diethyl diallylmalonate was achieved using this IiPrMe derivative and Os(phen)₃(PF₆)₂ (Os1) as photocatalyst. RCM was optimized successfully up to 85% yield, where the yield increased with decreased concentration (Table 1). Trace yields (<2%) were observed without light, without the Os photocatalyst, and without both. The RCM of several typical substrates to make 5-7 membered rings was achieved with modest to good yields (37-85%). Likewise, ROMP of 1,5-cyclooctadiene and norbornene is achieved with >95% conversion in one hour.

The results showed not only the ability to ring-close diallylmalonate but the control exerted by NIR light.

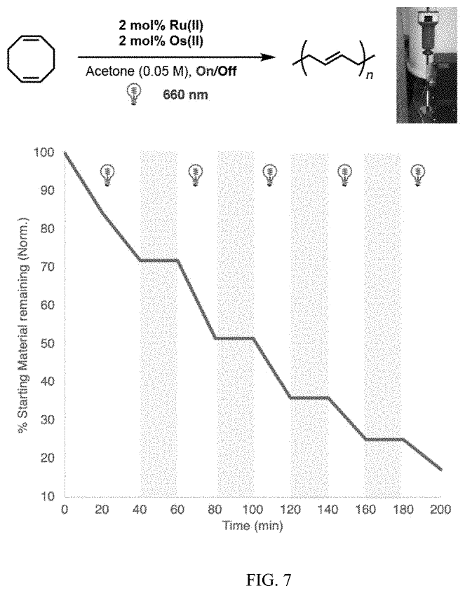

Without being bound by theory, the mechanism of activation, with the intent to showcase the enabling features afforded by NIR activation, is discussed below. In contrast to certain blue light system which proceeds by an oxidative mechanism,¹⁹ the yield in the NIR controlled system increases as more reducing OsII photocatalysts are used, despite the photocatalysts having similar triplet energies (Scheme 2). For example, Os2 and Os4 have triplet energies within approximately 1 kcal/mol of each other but deliver significantly different yields. The lack of Forster overlap between the Ru absorption and Os emission spectra is inconsistent with an energy transfer mechanism (FIG. 6B). There is a correlation, however, between the excited state oxidation potential of the Os photocatalysts and the yield. The discrepancy between the yields of Os3 and Os4 despite having a 50-mV difference in reduction potential can be explained by the rapid increase in intensity of the wave (Scheme 2). Finally, the addition of stoichiometric Zn to the reaction conditions provides 34% yield (Table 2, entry 1), which suggests that the mechanism could proceed through a reductive pathway to activating the Ru catalyst.

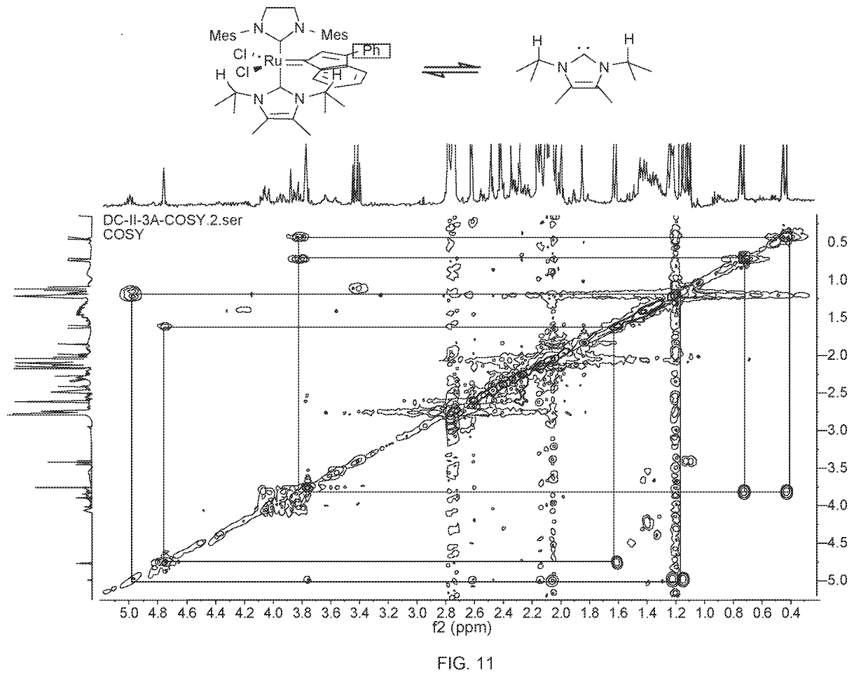

It was hypothesized that the smaller IiPrMe carbene²³ dissociates preferentially, consistent with literature precedent.²² This ligand dissociation was observed when the Ru catalyst is mixed with the photocatalyst and when the catalyst is mixed with ⁿBu₄NPF₆ in the dark (FIG. 10). However, the reaction gives trace yields in the presence of ⁿBu₄NPF₆ without photocatalyst (Table 2, entry 2).

TABLE 2
Additive screen.

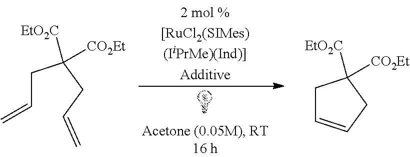 [SMILES: C=CCC(CC=C)(C(=O)OCC)C(=O)OCC ; CCOC(=O)C1(C(=O)OCC)CC=CC1]

| Entry | Additive | Light | Time | % Yield^{a} |
|---|---|---|---|---|
| 1 | 1 equiv. Zn | no light | 16 h | 34% |
| 2 | 20 mol % nBu₄NPF₆ | 660 nm | 16 h | trace |
| 3 | 20 mol % nBu₄NPF₆ | no light | 16 h | trace |
| 4 | 2 mol % Os1 | 660 nm | 4 h | 14% |
| 5 | 2 mol % Os1 | 660 nm | 4 h | 25% |
| | 20 mol % nBu₄NPF₆ | | | |
| 6 | 2 mol % Os1 | 660 nm | 16 h | NR |
| | 10 mol % IⁱPrMe | | | |

^{a}Yield by 1H NMR using mesitylene as internal standard

There is a slight increase in conversion when exogenous PF-salt is added (Table 2, entry 5); upon mixing the Os photocatalyst with Ru, the aldol product of acetone is observed, evidence of an unligated NHC.²³ Finally, addition of 10 mol % free carbene to the reaction completely arrests metathesis, suggesting that dissociation of IiPrMe is an essential step in the activation of the complex (Table 2, entry 6).

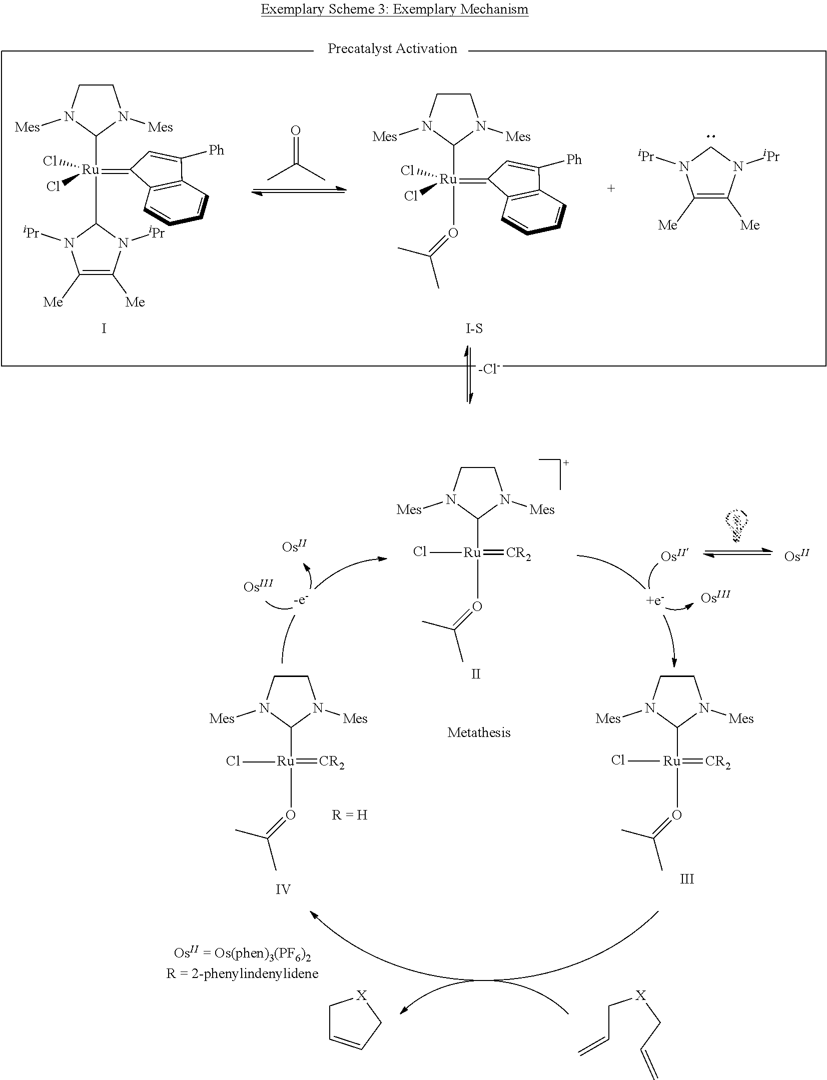

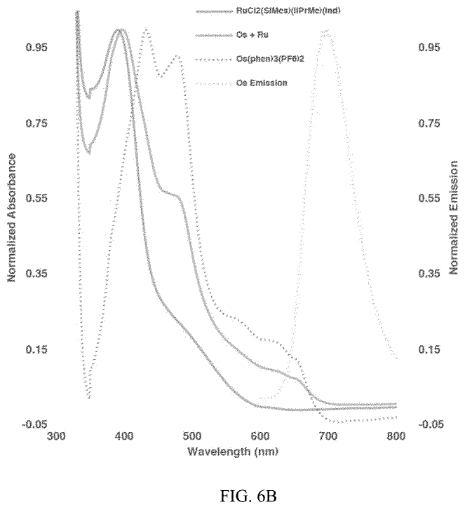

Nonetheless, these studies demonstrate that the NHC dissociation event is fast but is not caused by photoinduced electron transfer, as it occurs in the dark. Thus, it was posited that this event is required but not sufficient for reactivity. It was suggested that the electron transfer step comes after this initial chemical step. Through cyclic voltammetry, two waves were observed at the reductive pass at Eₕ=−0.85 V vs Ag/AgCl and −1.18 V vs Ag/AgCl in acetone. Comparing the CVs of Grubbs' II and its phenyl-indenylidene congener, an irreversible wave at−1.00 V vs Ag/AgCl was assigned as the reduction of the indenylidene (FIG. 5); however, this reduction is too far to be reached by the photocatalysts. The results suggest that the SET occurs at a new, cationic complex made in situ, which has a reduction potential of −0.85 V vs Ag/AgCl.

This mechanism was substantiated by time studies for the ring opening of 1,5-cyclooctadiene (COD), where a change in rate throughout the reaction was observed, consistent with a slow, initial activation step. When all components are mixed together, COD is fully consumed within 40 minutes. However, premixing the Ru precatalyst with Os1 for 10 minutes prior to monomer addition and irradiation results in a drastic increase in rate, where full consumption of COD is observed within 10 minutes (Scheme 4a). This suggests that a new complex is likely generated in situ as a result of acetone coordinating to the metal center, displacing the NHC (Scheme 3). The present inventors thus hypothesized aCCE mechanism where NHC dissociation and solvent association is followed by Cl− dissociation to generate a solvent bound, cationic complex II. This cationic complex can then be reduced electrochemically or via photoredox, which either leads to a more electron-rich and active 15 electron species III. Cationic ruthenium indenylidene complexes have been previously described in the literature, where a slow initial activation period was observed prior to increased reactivity.²⁴ From here, metathesis occurs to lead to the methylidene complex IV, and turnover of the osmium photocatalyst returns to the latent complex II to complete the catalytic cycle. Yield by ¹H NMR using 1,3,5-trimethoxybenzene as internal standard. b. Equivalents relative to [Ru]. 6×10-3 mmol Ru in 0.1 M nBu₄NPF₆ in acetone. Ag/AgCl reference electrode and Pt wire.

Using LED-illuminated NMR Spectroscopy,¹⁵ initial rate studies were conducted for the ring opening of COD at different chloride concentrations. It was observed that the rate decreases as the concentration of chloride increases, supportive of the hypothesized cationic complex mechanism (Scheme 4a). The reaction with 5 equiv. Cl⁻ was also performed in a lightbox with vigorous stirring and then stopped at 10 minutes. Starting material is not consumed in the presence of chloride, ensuring that the observed rate depreciation is due to the decrease in con-centration of the cationic complex and not due to photocatalystheterogeneity from anion exchange. The presence of a cationiccomplex is further corroborated by CV studies, where doping in ⁿBu₄NCl results in a decrease in intensity of the aforementioned irreversible wave at−0.85 V vs Ag/AgCl (Scheme 4b).

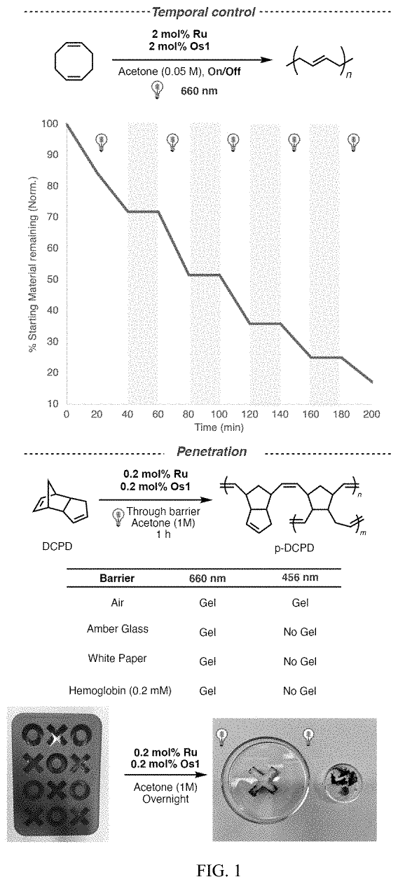

The applications of the NIR system to polymerization were then studied. It was demonstrated spatiotemporal control of metathesis with NIR light as well as the added advantage of polymerization through barriers, which could be used as an orthogonal, photochemical method to shaping dicyclopentadiene(DCPD) polymers compared to high temperature and pressure reaction injection molding. Using in situ LED-NMR, an On/Offstudy for the ring opening of COD was conducted. Excellent temporal control of the starting material consumption is observed, with no reactivity during the off periods (FIG. 1). Due to the thermal reactivity of typical ruthenium catalysts, this level of control can be difficult. However, by virtue of its mechanism, the reaction is dependent on light; thus reactivity is completely arrested in periods without irradiation.

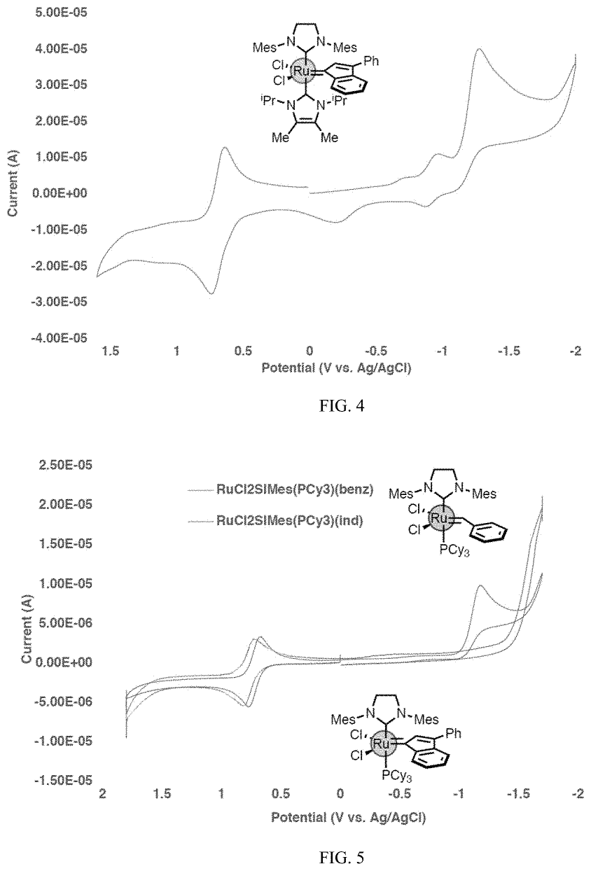

The ROMP of DCPD is also demonstrated to be spatially controlled using light, by moving a laser in a circular motion to draw a ring (FIG. 3). Even if other wavelengths of light could theoretically provide spatiotemporal control (as the Osmium photocatalyst can be activated from NIR to blue light), NIR light can penetrate through materials that lower wavelengths of light cannot, including biological tissue and Hemoglobin. Using this property of NIR light, the polymerization and crosslinking of DCPD through several barrier penetration tests were performed (FIG. 1). This was demonstrated through a simple flip test. Through amber glass, white paper, and a solution of Hemoglobin, free-standing gels of poly-DCPD are observed when using NIR light, but not with blue light. A larger scale polymerization was achieved by shining light onto a mold covered with a silicone pad (FIG. 1). The resulting polymers were shaped by the mold itself, indicating that the light had penetrated through the pad and initiated polymerization. Polymerization through the mold was attempted using blue light, which resulted in a thin film that could not be removed from the mold without complete destruction of its shape, while NIR light resulted in a 1 cm thick polymer.

According to certain exemplary embodiments of the present disclosure, a NIR light-controlled Ru catalyzed olefin metathesis reaction has been developed with applications in polymerization. The catalysts, compositions, systems and method according to exemplary embodiments of the present disclosure not only offer full spatiotemporal control for the catalyzed metathesis reaction, but also provide all advantages of NIR light over blue light regarding barrier penetration, allowing for new ways to mold and 3D print polymers.

### General Information

All reactions were carried out in anhydrous solvents and performed under ambient conditions unless otherwise noted. Commercial reagents and anhydrous solvents were purchased from Sigma-Aldrich, TCI, Matrix, Alfa-Aesar, and Oakwood Scientific. Thin layer chromatography wasperformed on SiliCycle® 250 μm, 60 A plates. Chromatographic purification was accomplished by flash chromatography on SiliCycle® Silica Flash® 40-63 μm, 60 Å. Visualization was accomplished with 254 nm UV light, I₂, or KMnO₄. The photocatalysts were synthesized according to the reported procedures.

All catalytic reactions were carried out under Ar in 1.5 dr vials fitted with Teflon caps underirradiation from PR160L-660 nm Kessil LED lamp, the lamp information of which is listed below:

Radiant Flux (optical output): 10,220 mW (10.22 W)
Intensity at 1 cm from light: 384.42 mW/cm\hat{ }2

### Power Consumption: Max. 35 W

For the molding study, a 700-800 nm LED lamp was purchased from powerPAR via Amazon.

Unless otherwise noted, ¹H NMR (500 MHz), ¹³C (126 MHz), and ¹⁹F (471 MHZ) spectra were taken on a Bruker 500 MHz spectrometer at ambient temperature and recorded in CDCl₃ Chemical shifts (6) are in parts per million relative to CDCl₃ (1H: 7.26 ppm, ¹³C: 77.16 ppm). Data for ¹H and ¹³C NMR is reported as follows: chemical shift (δ ppm), multiplicity (s=singlet, d=doublet, t=triplet, q=quartet, m=multiplet, brs=broad singlet), coupling constant (Hz), integration.

All cyclic voltammetry studies were performed on a CH Instruments Model 1232B potentiostat using an EDAQ 1-mm disk glassy carbon working electrode in conjunction with an EDAQ Ag/AgClreference electrode and a platinum wire from VWR as a counter electrode. All experiments were performed in anhydrous acetone.

Solutions were made in 1 cm×1 cm quartz cuvettes from Spectrocell and were prepared in the glovebox with anhydrous and sparged solvents then sealed before removing from the glovebox for measurement. UV-Vis Absorption spectra were obtained on an Agilent Technologies Cary 60UV-Vis spectrophotometer. Fluorimetry spectra were obtained on Perkin Elmer LS-55.

In situ LED-NMR experiments were performed with Goldstone Marketing LLC Mic-LED-655Z equipped with current controller BLCC-04, the potentiometer of which was set to 2.0, fiber coupling adapter FCA-SMA, and fiber patch cord (Extra Long) were purchased.

Safety Statement: OsO₄ is a known toxin. The low-valent Os (II) octahedral complexes used in this study are known to have low toxicity. Upon exposure to oxygen and under light irradiation or mild heating, no oxidation to high valent Os was observed. Nevertheless, precautions have been and should be taken. The Os complexes was synthesized under an inert atmosphere. The corresponding Os-contaminated waste is contained separately from other waste streams and is treated with corn oil to quench any possible OsO₄ generated over time. While any decomposition of the Os complexes used in this study to OsO₄ was not observed while storing in a desiccator on the benchtop, storing the complexes in the glovebox to limit exposure to moisture and oxygen is recommended.

### Exemplary Photocatalyst Screen and Additive Screen

0.02 M stock solutions of each Os photocatalyst in anhydrous acetone were prepared in an Ar glovebox. In addition, a 0.02 M stock solution of RuCl₂(SIMes)(IiPrMe)(ind) was prepared by dissolving 17 mg of the complex in 1 mL anhydrous acetone. In a vial, 100 μL from the Ru stocksolution and 100 μL from the Os stock solution was added, after which 24.2 μL of diethyldiallylmalonate was added. The vial is then diluted to 2 mL anhydrous acetone, stirred in a lightbox, and irradiated with 660 nm lamps for 16 hours. After 16 hours, the vial was concentrated. NMR yields were taken in CDCl₃ with 0.1 mmol mesitylene as internal standard.

The catalysts were synthesized in a previous publication.²⁶ Photophysical data was obtained by taking 5×10⁻⁴ M solutions of each catalyst in anhydrous acetone. CV data was obtained by measuring 0.002 mmol of each catalyst in a 0.1 M solution ⁿBu₄NPF₆ in anhydrous acetone bubbled with N₂ for 10 minutes prior to measurement.

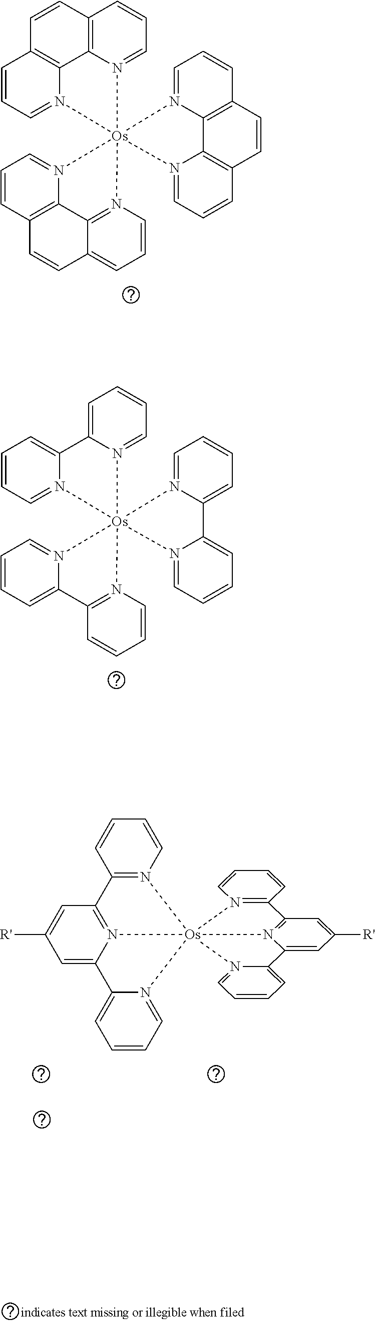

| Os Cat | Os(II/III) | Os(II/I) | T1(eV) | T1 (kcal/mol) | Os(II*/III) | Os(II*/I) | Percent Yield |
|---|---|---|---|---|---|---|---|
| Os1 | 0.9785 | −1.364 | 1.91 | 44.123 | −0.9315 | 0.546 | 85.5 |
| Os2 | 0.988 | −1.062 | 1.85 | 42.547 | −0.862 | 0.788 | 76.5 |
| Os3 | 1.0835 | −1.008 | 1.83 | 42.17 | −0.7465 | 0.822 | 63 |
| Os4 | 1.077 | −0.962 | 1.78 | 41.257 | −0.703 | 0.818 | 11.25 |
| Os5 | 1.1445 | −0.893 | 1.76 | 40.613 | −0.6155 | 0.867 | 2.25 |

### Exemplary Additive Screen

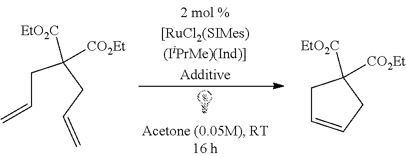 [SMILES: C=CCC(CC=C)(C(=O)OCC)C(=O)OCC ; CCOC(=O)C1(C(=O)OCC)CC=CC1]

| Additive | Light | Time | % Yield^{a} |
|---|---|---|---|
| 1 equiv. Zn | no light | 16h | 34% |
| 20 mol % nBu₄NPF₆ | 660 nm | 16h | trace |
| 20 mol % nBu₄NPF₆ | no light | 16h | trace |
| 2 mol % Os1 | 660 nm | 4h | 14% |
| 2 mol % Os1 | 660 nm | 4h | 25% |
| 20 mol % nBu₄NPF₆ | | | |
| 2 mol % Os1 | 660 nm | 16h | NR |
| 10 mol % IⁱPrMe | | | |

The additive screen was conducted by using the procedure to Ring Closing Metathesis described below and analyzing the resulting reaction mixture by ¹H-NMR using mesitylene as an internal standard.

### Exemplary Synthesis and Characterization of Starting Materials and Reagents

Preparation of Photocatalyst

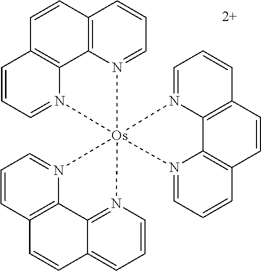

Os(phen)₃(PF₆)₂ was prepared according to a previously reported procedure. To a dry sealed tube, 2.0 mmol (4 equiv.) phenanthroline is added. The tube is taken to a glovebox, where it is evacuated and refilled 3× with N₂. 0.5 mmol (lequiv.) OsCl₃ is added to the sealed tube and 6.67 mL (0.075 M) of ethylene glycol is added. The tube is placed in a sand bath heated to 230° C. for 48 hours. Caution, this reaction may develop pressure. A blast shield placed in front of the reaction is recommended. After 48 hours, the reaction is cooled to 60° C., 5.0 mmol (10 equiv.) nBu₄PF₆ and 6.67 mL DI H₂O is added in air. After 45 minutes, the precipitate is collected on filter paper and dried between another piece of filter paper. The precipitate is washed with H₂O 3× and Et₂O 3×, after which the precipitate is collected and dried in vacuo overnight. Characterization data matches previously reported data.²⁷

### Exemplary Product Synthesis and Characterization Data

### Representative Procedure for Ring Closing Metathesis

To a 1.5 d vial with equipped with a stir bar, 2.00 mg of Os(phen)₃(PF₆)₂(0.002 mmol, 2 mol %) is added. The vial is taken to an Ar glovebox, where 1.70 mg of RuCl₂(SIMes)(IiPrMe)(ind) (0.002 mmol, 2 mol %) is added. 0.1 mmol of the substrate is pipetted into the vial, along with 1 mL anhydrous acetone. The vial is removed from the glovebox and irradiated with 660 nm lights in a lightbox with the fan on to maintain an internal temperature of 25-30° C. After 16 hours, the reaction mixture is concentrated under vacuum and purified by flash column chromatography on silica gel (90:10 Hexanes:EtOAc, visualized by I₂ or KMnO₄).

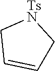 [SMILES: Cc1ccc(S(=O)(=O)N2CC=CC2)cc1]

1-tosyl-2,5-dihydro-1H-pyrrole. 85% yield. Characterization data matches previously reported data.²⁶

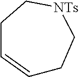 [SMILES: Cc1ccc(S(=O)(=O)N2CCC=CCC2)cc1]

1-tosyl-2,3,6,7-tetrahydro-1H-azepine. 84% yield. Characterization data matches previously reported data.²⁹

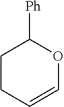 [SMILES: C1=COC(c2ccccc2)CC1]

2-phenyl-3,4-dihydro-2H-pyran. 37% yield. Characterization data matches previously reported data.³⁰

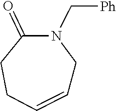 [SMILES: O=C1CCC=CCN1Cc1ccccc1]

1-benzyl-1,3,4,7-tetrahydro-2H-azepin-2-one. 66% yield. Characterization data matches previously reported data.³¹

### Representative Procedure for Cross Metathesis

To a 1.5 d vial equipped with a stir bar, 2.00 mg of Os(phen)₃(PF₆)₂(0.002 mmol, 2 mol %) is added. The vial is taken to an Ar glovebox, where 1.70 mg of RuCl₂(SIMes)(IⁱPrMe)(ind) (0.002 mmol, 2 mol %) is added. 0.1 mmol of one substrate and 0.2 mmol of the other are pipetted into the vial, along with 1 mL anhydrous acetone. The vial is removed from the glovebox and irradiated with 660 nm lights in a lightbox with the fan on to maintain an internal temperature of 25-30° C. After 16 hours, the reaction mixture is concentrated under vacuum and purified by flash column chromatography on silica gel (90:10 Hexanes:EtOAc, visualized by I₂ or KMnO₄).

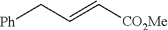 [SMILES: COC(=O)/C=C/Cc1ccccc1]

Methyl (E)-4 phenylbut-2-enoate. 30% yield. Characterization data matches previously reported data.³²

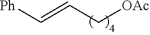

(E)-6-phenylhex-5-en-1-yl acetate. 29% yield. Characterization data matches previously reported data.³³

### Exemplary Polymerization Methods

To a scintillation vial, 2.00 mg of Os(phen)₃(PF₆)₂(0.002 mmol, 0.2 mol %) is added along with 132 mg dicyclopentadiene. The vial is taken to an Ar glovebox, where 1.70 mg of RuCl₂(SIMes)(IiPrMe)(ind) (0.002 mmol, 0.2 mol %) is added along with 1 mL dry acetone. The vial is irradiated with either 427 or 660 nm light for 1 hour. The reaction mixture is then thoroughly washed with DCM to produce a freestanding gel.

Barrier Penetration

The method described above was used for the barrier penetration studies.

White paper: A 2×8.5 in piece of paper was cut and wrapped around a 1.5 d vial then secured with tape.

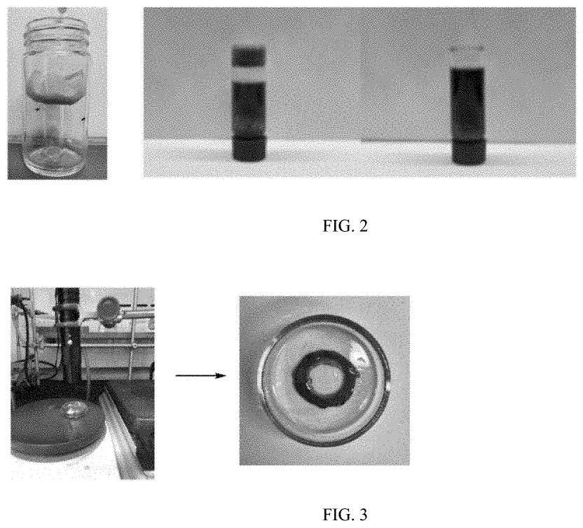

Hemoglobin: The vial was placed inside of a 4 cm diameter glass chamber filled with a 0.2 mM solution of Bovine Hemoglobin in DI water sparged with Ar. The vial is fitted at the top with foam to secure the vial (see FIG. 2).

The Hemoglobin solution heats up to around 35° C. upon irradiation, and polymerization was observed with blue light, although a freestanding gel was not observed.

Spatial Control

The method above was used for spatial control studies. As previously reported, the solution is placed into a petri dish below a red laser focused by a magnifying glass. The laser is clamped onto an orbital shaker to produce a brittle, circular shaped polymer (FIG. 3).

### Through Mold Experiment

To a scintillation vial in air, 8.5 mg of RuCl₂(SIMes)(IiPrMe)(ind) (0.01 mmol, 0.2 mol %) and 10 mg of Os(phen)₃(PF₆)₂(0.01 mmol, 0.2 mol %) are added and dissolved in 2 mL anhydrous acetone. 661 mg of dicyclopentadiene (5 mmol) is added in a second vial and dissolved in 3 mL anhydrous acetone. The DCPD solution is added to the silicone mold and the catalyst mixture is pipetted into the solution. The mold is sealed with a 7 mm white silicone pad and irradiated with a 700-800 nm LED lamp purchased from Amazon overnight. The mold was thoroughly washed with MeOH then DCM, and the brittle white polymer was carefully removed using tweezers.

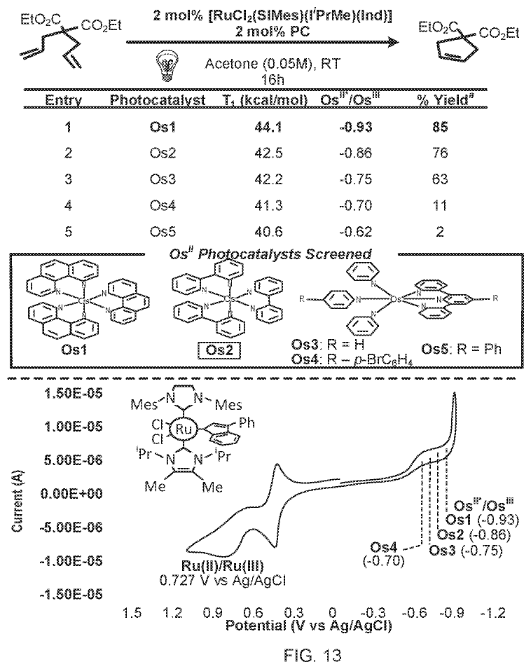

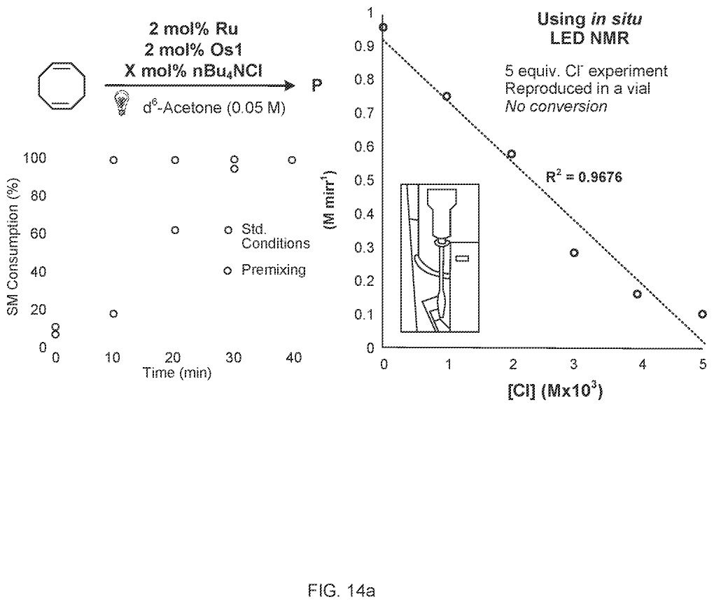

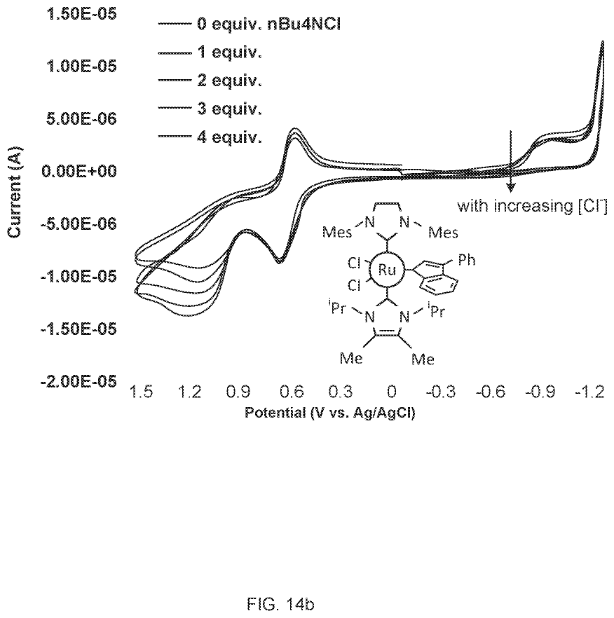

The resulting polymer was 2.5 cm×2.5 cm×1 cm in the shape of the mold (see FIG. 12).

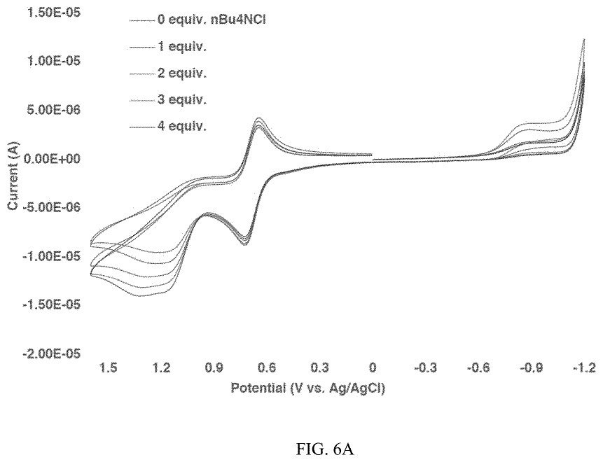

### Exemplary Electrochemical Data (FIGS. 4 to 5A)

Cyclic voltammetry studies were run using a glassy carbon electrode, a platinum wire counter electrode, and an Ag/AgCl reference electrode. For all studies, tetrabutylammonium hexafluorophosphate was used as the electrolyte in a solution of anhydrous acetone (RuCl₂SIMes(IiPrMe)(ind)) or dichloromethane (Grubbs' II and RuCl₂(SIMes)(PCy₃)(ind)), while argon was bubbled through the solution prior to data collection. Sweeps of negative (reductive) and positive (oxidative) on first pass were run.

To an electrochemical cell with a stir bar, 77.5 mg (0.2 mmol) of nBu₄PF₆ is added. The cell is transferred to a glovebox, where 5.00 mg (0.006 mmol) of RuCl₂SIMes(IiPrMe)(ind) is added along with 2 mL dry acetone. The electrodes are added, and the cell is bubbled with Ar for 20 minutes with stirring through a bubbler containing dry acetone.

A stock solution of 8.34 mg (0.03 mmol) nBu₄C₁ in 2 mL dry acetone is prepared. 100 μL of this stock solution was added to the cell after each CV was taken and the solution was bubbled with Ar with stirring.

### Exemplary Spectroscopic Data (FIG. 5B)

General Procedure: A 0.001 M stock solution of the analyte is prepared in anhydrous acetone. 100 μL of the solution is transferred to a cuvette with a path length of 1 cm. The sample is then diluted to 2 mL anhydrous acetone. UV-Vis Absorption spectra were obtained on an Agilent Technologies Cary 60 UV-Vis spectrophotometer. Fluorimetry spectra were obtained on Perkin Elmer LS-55.

The lack of spectral overlap between the Ruthenium absorption spectrum and the Osmium's emission spectrum suggests that Forster energy transfer (EnT) is not a likely mechanism to activation.

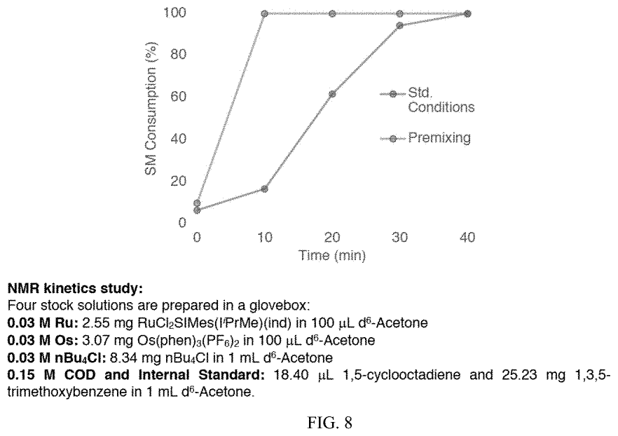

### Exemplary Temporal Control Experiment (FIG. 7)

In a 1.5 d vial, 2.0 mg of Os(phen)₃(PF₆)₂ (0.002 mmol, 2 mol %) and 16.8 mg of 1,3,5-trimethoxybenzene is added. The vial is taken to a glovebox, where 1.7 mg of RuCl₂(SIMes)(IiPrMe)(ind) (0.002 mmol, 2 mol %) is added, along with 12.26 μL COD and 2 mL d⁶-Acetone. 300 μL of this solution was transferred to an NMR tube fitted with the light insert. The tube is taken out of the glovebox, and the LED cord is inserted and secured with Parafilm. The tube and spinner are then carefully spooled into a 500 MHz NMR spectrometer, The first 40 minutes were irradiated to track the initial kinetics of the reaction, after which it was decided that periods of irradiation and non-irradiation are conducted every 20 minutes. Consumption was tracked by integrating the methylene protons of COD at 2.36 ppm against the O—CH₃ protons of trimethoxybenzene at 3.76 ppm. The data is normalized.

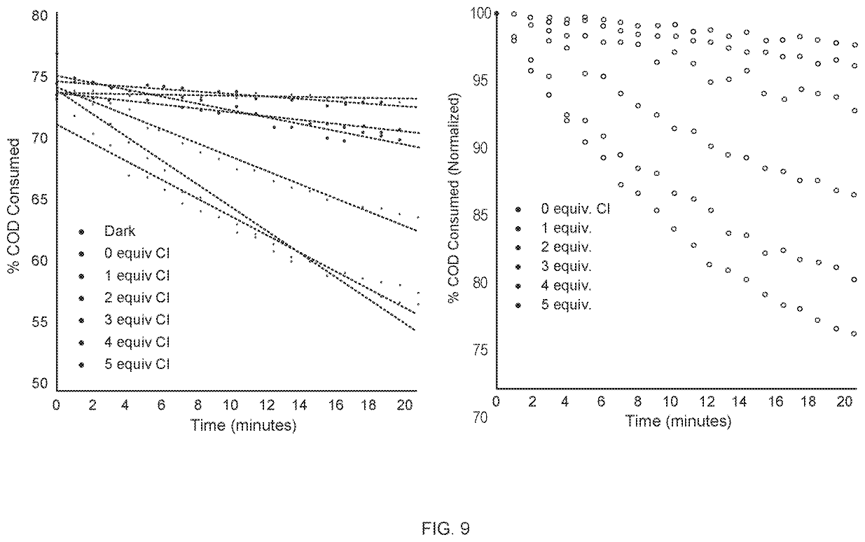

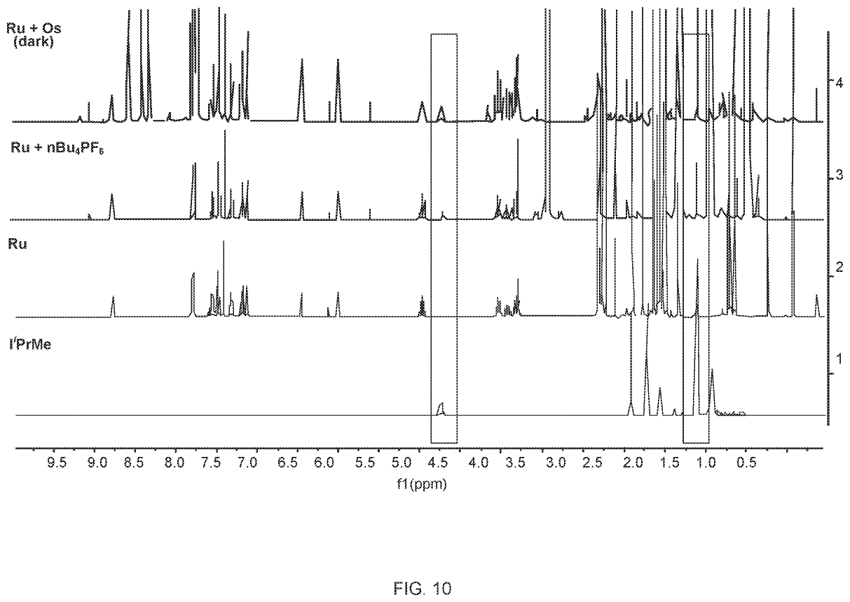

Kinetics Experiment (FIGS. 8 and 9)

A vial was prepared using the standard procedure with 0.1 mmol COD and 0.1 mmol 1,3,5-trimethoxybenzene as internal standard in 2 mL d⁶-Acetone. Aliquots were taken every 10 minutes. In the “premixing” condition, the Osmium and Ruthenium catalysts were stirred, nonirradiated, for 10 minutes prior to addition of COD and irradiation. The Ruthenium catalyst was also stirred in acetone prior to addition of the Osmium and COD and irradiation, which resulted in the same increase in rate.

To a vial, in air, 100 μL of COD and IS, 10 μL of Ru, 10 μL of Os, and varying volumes of ⁿBu₄Clare pipetted. The vial is then diluted to 300 μL with d⁶-Acetone, sealed and sonicated, then transferred to an NMR tube covered with foil. Before each NMR is taken, the light insert containing the fiber cord LED is carefully added to avoid breaking the glass insert in the tube. The NMR tube is placed in a spinner and the LED wire is secured by Parafilm. The tube and spinner are then carefully spooled into a 500 MHz NMR spectrometer, and a ¹H NMR is taken before the light is turned on. Then, using the Bruker kinetics zg2d pulse program, successive spectra were taken after 60 seconds for 21 minutes, the light being turned on after the first acquisition (Scan 1 is t=0).

Starting material consumption was tracked by integrating the methylene protons of COD at 2.36 ppm against the O—CH₃ protons of trimethoxybenzene at 3.76 ppm. Note that as the [Cl⁻] increases, catalyst does crash out. However, this rate effect was reproduced by running this reaction under vigorous stirring while irradiated with two 660 nm lamps, which gave no conversion. Therefore, it is believed that photocatalyst heterogeneity is not a major contributor to the observed rate decrease.

Each equivalent of Cl⁻ is relative to Ruthenium precatalyst.

### NMR Studies

FIG. 10 shows an exemplary graph showing addition of nBu₄PF₆ to Ru complex in acetone leads to NHC dissociation.

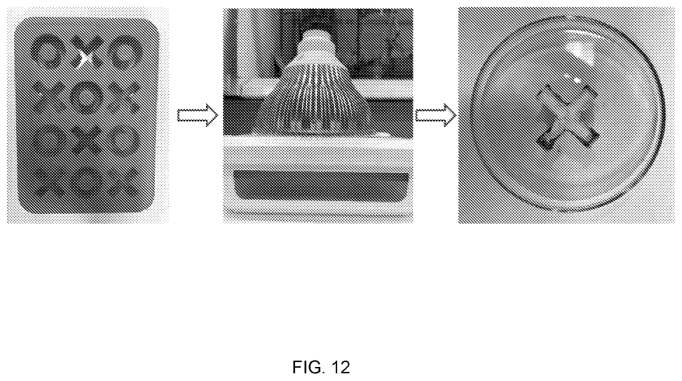

FIG. 11 shows exemplary COSY of Ru and Os1 mixture shows dissociation of IiPrMe via loss of diastereotopic isopropyl protons.

FIG. 12 shows an exemplary result of the through mold experiment.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

The following references are hereby incorporated herein in their entireties:
(1) Grubbs, R. H.; Chang, S. Recent Advances in Olefin Metathesis and Its Application in Organic Synthesis. Tetrahedron 1998, 54 (18), 4413-4450.
(2) Cesar, V.; Lavigne, G. Olefin Metathesis: Theory and Practice. Edited by Karol Grela. Angew. Chem. Int. Ed. 2015, 54 (13), 3856-3857.
(3) Hoveyda, A. H.; Zhugralin, A. R. The Remarkable Metal-Catalysed Olefin Metathesis Reaction. Nature 2007, 450 (7167), 243-251.
(4) Higman, C. S.; Lummiss, J. A. M.; Fogg, D. E. Olefin Metathesis at the Dawn of Implementation in Pharmaceutical and Specialty-Chemicals Manufacturing. Angew. Chem. Int. Ed. 2016, 55 (11), 3552-3565.
(5) Matson, J. B.; Grubbs, R. H. ROMP-ATRP Block Copolymers Prepared from Monotelechelic Poly(Oxa)Norbornenes Using a Difunctional Terminating Agent. Macromolecules 2008, 41 (15), 5626-5631.
(6) Haque, T.; Nomura, K. Acyclic Diene Metathesis (ADMET) Polymerization for Precise Synthesis of Defect-Free Conjugated Polymers with Well-Defined Chain Ends. Catalysts 2015, 5 (2), 500-517.
(8) Naumann, S.; Buchmeiser, M. R. Latent and Delayed Action Polymerization Systems. Macromol. Rapid Commun. 2014, 35 (7), 682-701.
(9) Doerr, A. M.; Burroughs, J. M.; Gitter, S. R.; Yang, X.; Boydston, A. J.; Long, B. K. Advances in Polymerizations Modulated by External Stimuli. ACS Catal. 2020, 10 (24), 14457-14515.
(10) Varnado, C. D.; Jr; Rosen, E. L.; Collins, M. S.; Lynch, V. M.; Bielawski, C. W. Synthesis and Study of Olefin Metathesis Catalysts Supported by Redox-Switchable Diaminocar-bene[3]Ferrocenophanes. Dalton Trans. 2013, 42 (36), 13251-13264.
(11) El-Shahawi, M. S.; Shoair, A. F. Synthesis, Spectroscopic Characterization, Redox Properties and Catalytic Activity of Some Ruthenium (II) Complexes Containing Aromatic Alde-hyde and Triphenylphosphine or Triphenylarsine. Spectrochim. Acta. A. Mol. Biomol. Spectrosc. 2004, 60 (1), 121-127.
(12) Ahumada, G.; Ryu, Y.; Bielawski, C. W. Potentiostatically Controlled Olefin Metathesis. Organometallics 2020, 39 (10), 1744-1750.
(13) Piermattei, A.; Karthikeyan, S.; Sijbesma, R. P. Activating Catalysts with Mechanical Force. Nat. Chem. 2009, 1 (2), 133-137.
(14) Vidavsky, Y.; Lemcoff, N. G. Light-Induced Olefin Metathesis. Beilstein J. Org. Chem. 2010, 6 (1), 1106-1119.
(15) Keitz, B. K.; Grubbs, R. H. A Tandem Approach to Photoactivated Olefin Metathesis: Combining a Photoacid Generator with an Acid Activated Catalyst. J. Am. Chem. Soc. 2009, 131 (6), 2038-2039.
(16) Eivgi, O.; Vaisman, A.; Lemcoff, N. G. Latent, Yet Highly Active Photoswitchable Olefin Metathesis Precatalysts Bearing Cyclic Alkyl Amino Carbene (CAAC)/Phosphite Ligands. ACS Catal. 2021, 11 (2), 703-709.
(17) Nechmad, N. B.; Lemcoff, N. G. Sulfur-Chelated Ruthenium Olefin Metathesis Catalysts. Synlett 2020.
(18) Ogawa, K. A.; Goetz, A. E.; Boydston, A. J. Metal-Free Ring-Opening Metathesis Polymerization. J. Am. Chem. Soc. 2015, 137 (4), 1400-1403.
(19) Theunissen, C.; Ashley, M. A.; Rovis, T. Visible-Light-Controlled Ruthenium-Catalyzed Olefin Metathesis. J. Am. Chem. Soc. 2019, 141 (17), 6791-6796.
(20) Bantreil, X.; Randall, R. A. M.; Slawin, A. M. Z.; Nolan, S. P. Ruthenium Complexes Bearing Two N-Heterocyclic Carbene Ligands in Low Catalyst Loading Olefin Metathesis Re-actions. Organometallics 2010, 29 (13), 3007-3011.
(21) Ravetz, B. D.; Tay, N. E. S.; Joe, C. L.; Sezen-Edmonds, M.; Schmidt, M. A.; Tan, Y.; Janey, J. M.; Eastgate, M. D.; Rovis, T. Development of a Platform for Near-Infrared Photoredox Catalysis. ACS Cent. Sci. 2020, 6 (11), 2053-2059.
(22) Kuhn, N.; Kratz, T. Synthesis of Imidazol-2-Ylidenes by Reduction of Imidazole-2(3H)-Thiones. Synthesis 1993, 1993 (6), 561-562.
(23) We propose that the salt facilitates the deprotonation of acetone (pKa=26 in DMSO) by the free NHC (pKa=24 in DMSO). This deprotonation was probed by stirring the free NHC in acetone, where the aldol product of acetone is observed only when nBu4NPF6 is added. For the pKa of the NHC, see: Alder, R. W.; Allen, P. R.; Williams, S. J. Stable Carbenes as Strong Bases. J. Chem. Soc. Chem. Commun. 1995, No. 12, 1267-1268.
(24) Songis, O.; Slawin, A. M. Z.; Cazin, C. S. J. An Unusual Cationic Ru(II) Indenylidene Complex and Its Ru(III) Derivative-Efficient Catalysts for High Temperature Olefin Metathesis Reactions. Chem. Commun. 2012, 48 (9), 1266-1268.
(25) Ji, Y.; DiRocco, D. A.; Hong, C. M.; Wismer, M. K.; Reibarkh, M. Facile Quantum Yield Determination via NMR Actinometry. Org. Lett. 2018, 20 (8), 2156-2159.
(26) Ravetz, B. D.; Tay, N. E. S.; Joe, C. L.; Sezen-Edmonds, M.; Schmidt, M. A.; Tan, Y.; Janey, J. M.; Eastgate, M. D.; Rovis, T. Development of a Platform for Near-Infrared Photoredox Catalysis. ACS Cent. Sci. 2020, 6 (11), 2053-2059.
(27) Demadis, K. D.; Dattelbaum, D. M.; Kober, E. M.; Concepcion, J. J.; Paul, J. J.; Meyer, T. J.; White, P. S. Vibrational and Structural Mapping of [Os(Bpy)_{3]3+/}2+ and [Os(Phen)_{3]3+/}2+. Inorg. Chim. Acta 2007, 360 (3), 1143-1153.
(28) Hongfa, C.; Tian, J.; Bazzi, H. S.; Bergbreiter, D. E. Heptane-Soluble Ring-ClosingMetathesis Catalysts. Org. Lett. 2007, 9 (17), 3259-3261.
(29) Wu, G.-L.; Cao, S.-L.; Chen, J.; Chen, Z. Synthesis of Pyrimidine-Modified NHC Ruthenium-Alkylidene Catalysts and Their Application in RCM, CM, EM and ROMPReactions. Eur. J. Org. Chem. 2012, 2012 (34), 6777-6784.
(30) Broggi, J.; Urbina-Blanco, C. A.; Clavier, H.; Leitgeb, A.; Slugovc, C.; Slawin, A. M. Z.; Nolan, S. P. The Influence of Phosphane Ligands on the Versatility of Ruthenium—Indenylidene Complexes in Metathesis. Chem.—Eur. J. 2010, 16 (30), 9215-9225.
(31) Rix, D.; Caijo, F.; Laurent, I.; Boeda, F.; Clavier, H.; Nolan, S. P.; Mauduit, M. Aminocarbonyl Group Containing Hoveyda-Grubbs-Type Complexes: Synthesis and Activity in Olefin Metathesis Transformations. J. Org. Chem. 2008, 73 (11), 4225-4228.
(32) Wang, S.-Y.; Ji, S.-J.; Loh, T.-P. Cu(I) Tol-BINAP-Catalyzed Enantioselective Michael Reactions of Grignard Reagents and Unsaturated Esters. J. Am. Chem. Soc. 2007, 129(2), 276-277.
(33) Han, J.; Sun, X.; Wang, X.; Wang, Q.; Hou, S.; Song, X.; Wei, Y.; Wang, R.; Ji, W. Covalent Organic Framework as a Heterogeneous Ligand for the Regioselective Oxidative Heck Reaction. Org. Lett. 2020, 22 (4), 1480-1484.

What is claimed is:

1. A composition for catalyzing formation of a carbon-carbon double bond, comprising:
a ruthenium catalyst; and
a photocatalyst that is activated by a deep red to near-infrared light.

2. The composition of claim 1, wherein the deep red to near-infrared light has a wavelength of about 600 nm to about 800 nm.

3. The composition of claim 1, wherein the ruthenium catalyst comprises a compound represented by the following Formula (I): 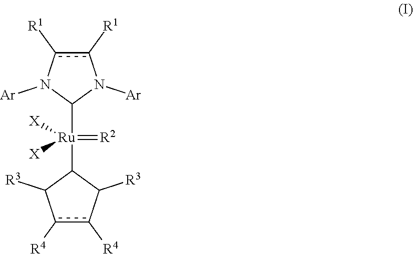
wherein [symbol]
indicates a single bond or a double bond;
R¹, R⁴ is, independently, hydrogen, or an optionally substituted aliphatic group or an optionally substituted aromatic group;
Ru═R² is 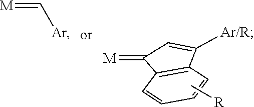
R² is a benzylidene group, where the aromatic ring is optionally independently substituted with hydrogen or substituted with 1 to 5 substituents containing an aliphatic moiety, an aromatic moiety, or a heteroatom at any position, or a combination thereof, or a substituted indenylidene groups having 1 to 6 substituents containing hydrogen, an aliphatic moiety, an aromatic moiety, or a heteroatom at any position of the ring, or a combination thereof,
each occurrence of Ar, independently, is 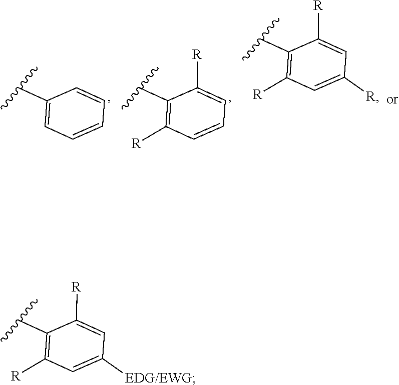
EWG is ester, cyano, nitro, trifluoromethyl, ketone, or halogen;
EDG is ether, an amine group, an alcohol group, or an aliphatic group;
Each occurrence of R, independently, is an optionally substituted aliphatic group;
R³ is an optionally substituted aliphatic or an optionally substituted aromatic group;
The bis-N-heterocyclic carbene (NHC) ligand may be saturated or unsaturated;
X is a halogen, or a X-type ligand.

4. The composition of claim 3, wherein Ru═R² is

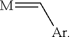

5. The composition of claim 3, wherein Ru═R² is

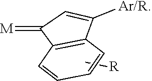

6. The composition of claim 1, wherein the ruthenium catalyst comprises 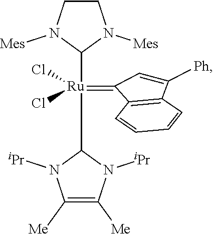
wherein Mes is a mesityl group, ⁱPr is isopropyl, and Ph is phenyl.

7. The composition of claim 1, wherein the photocatalyst comprises an osmium photocatalyst.

8. The composition of claim 7, wherein the osmium photocatalyst comprises: 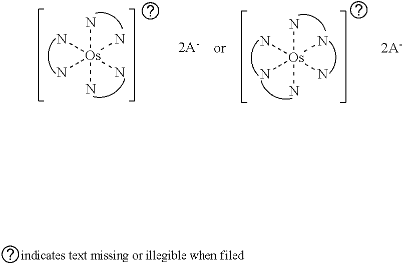
or
a combination thereof, wherein: 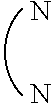
is 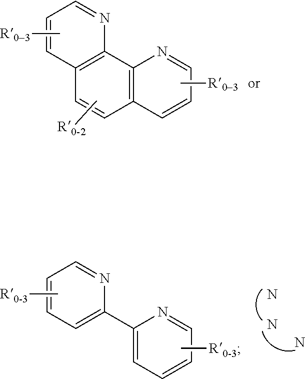
is 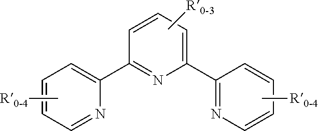
A⁻ is an anion;
each occurrence of R′, independently, is hydrogen, an optionally substituted aliphatic group, an optionally substituted aromatic group, or a optionally substituted functional group containing a heteroatom;
R′₀₋₂ indicates that 0 to 2 groups of R′ are substituted in a ring to which it is attached;
R′₀₋₃ indicates that 0 to 3 groups of R′ are substituted in a ring to which it is attached; and
R′₀₋₄ indicates that 0 to 2 groups of R′ are substituted in a ring to which it is attached.

9. The composition of claim 8, wherein R′ is H, p-BrC₆H₄ or phenyl.

10. The composition of claim 7, wherein the osmium photocatalyst comprises at least one selected from the group consisting of: 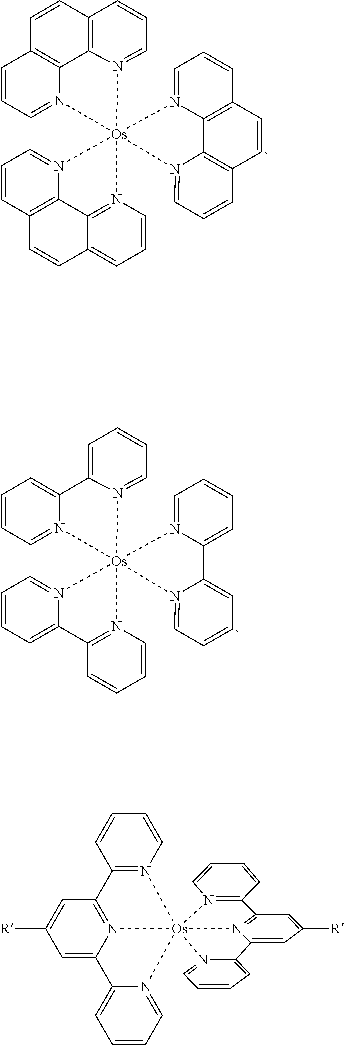
wherein R′ is H, 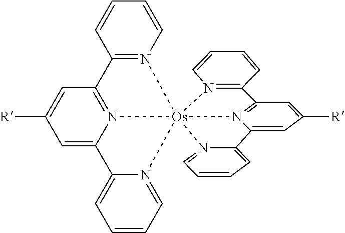
wherein R′ is p-BrC₆H₄, 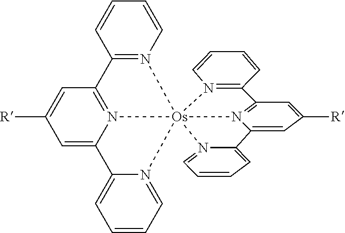
wherein R′ is Ph, and
a combination thereof.

11. A method for catalyzing formation of a carbon-carbon double bond, the method comprising applying a deep red to near-infrared light to a reaction system comprising the composition according to claim 1.

12. The method of claim 11, wherein the deep red to near-infrared light has a wavelength of about 600 nm to about 800 nm.

13. A method for chemical metathesis, comprising applying a deep red to near-infrared light to (i) a compound comprising a first alkenyl group and a second alkenyl group or (ii) a first compound comprising a first alkenyl group and a second compound comprising a second alkenyl group, in the presence of the composition according to claim 1.

14. The method of claim 13, wherein the deep red to near-infrared light has a wavelength of about 600 nm to about 800 nm.

15. A method for spatial and/or temporal control of a metathesis, comprising:
forming a mixture of a ruthenium catalyst, a photocatalyst, and one or more compounds susceptible to metathesis; and
applying a deep red to near-infrared light to the mixture at at least one of (i) a predetermined time or (ii) one or more predetermined regions of the mixture.

16. The method of claim 15, wherein the deep red to near-infrared light has a wavelength of about 600 nm to about 800 nm.

17. The method of claim 15, wherein the ruthenium catalyst comprises a compound represented by the following Formula (I): 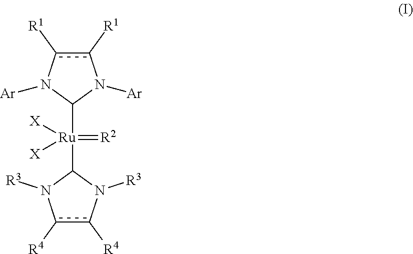
wherein [symbol]
indicates a single bond or a double bond;
R¹, R⁴ is, independently, hydrogen, or an optionally substituted aliphatic group or an optionally substituted aromatic group;
Ru═R² is 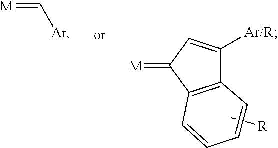
R² is a benzylidene group that is optionally independently substituted with hydrogen or substituted with 1 to 5 substituents containing an aliphatic moiety, an aromatic moiety, or a heteroatom at any position, or a combination thereof, or a substituted indenylidene groups having 1 to 6 substituents containing hydrogen, an aliphatic moiety, an aromatic moiety, or a heteroatom at any position of the ring, or a combination thereof;
each occurrence of Ar, independently, is 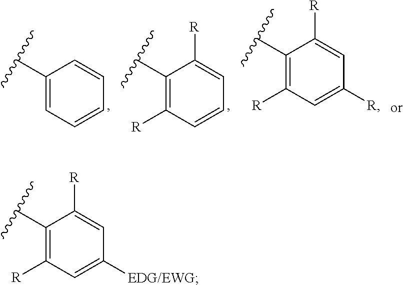
EWG is ester, cyano, nitro, trifluoromethyl, ketone, or halogen;
EDG is ether, an amine group, an alcohol group, or an aliphatic group;
Each occurrence of R, independently, is an optionally substituted aliphatic group;
R³ is an optionally substituted aliphatic or an optionally substituted aromatic group;
The bis-N-heterocyclic carbene (NHC) ligand may be saturated or unsaturated;
X is a halogen, or a X-type ligand.

18. The method of claim 15, wherein Ru═R² is

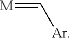

19. The method of claim 15, wherein Ru═R² is

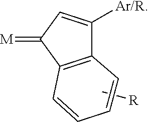

20. The method of claim 15, wherein the photocatalyst comprises 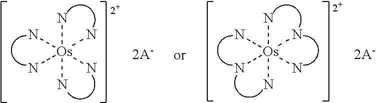
or
a combination thereof, wherein: 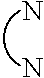
is 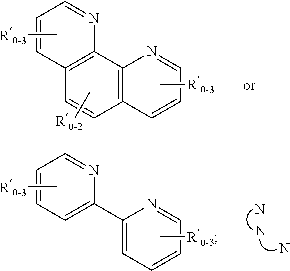
is 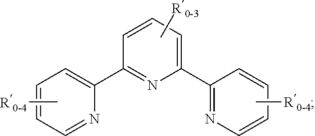
A⁻ is an anion;
each occurrence of R′, independently, is hydrogen, an optionally substituted aliphatic group, an optionally substituted aromatic group, or a optionally substituted functional group containing a heteroatom;
R′₀₋₂ indicates that 0 to 2 groups of R′ are substituted in a ring to which it is attached;
R′₀₋₃ indicates that 0 to 3 groups of R′ are substituted in a ring to which it is attached; and
R′₀₋₄ indicates that 0 to 2 groups of R′ are substituted in a ring to which it is attached.
